(19) United States
(12) Patent Application Publication
(10) Pub. No.: US 2026/0025819 A1
(43) Pub. Date: Jan. 22, 2026

(54) RESOURCE ALLOCATION OF UPLINK CONTROL INFORMATION ON A SHARED CHANNEL

(71) Applicant: QUALCOMM Incorporated, San Diego, CA (US)

(72) Inventors: Akash Sandeep DOSHI, San Diego, CA (US); Wei YANG, San Diego, CA (US); June NAMGOONG, San Diego, CA (US); Jing JIANG, San Diego, CA (US); Taesang YOO, San Diego, CA (US); Peter GAAL, San Diego, CA (US)

(21) Appl. No.: 18/780,346

(22) Filed: Jul. 22, 2024

(51) Int. Cl. H04W 72/21; H04W 72/0453

(52) U.S. Cl. CPC H04W 72/21; H04W 72/0453

(57) ABSTRACT

Methods, systems, and devices for wireless communications are described. A UE may allocate uplink control information (UCI) to symbols with a time-first mapping scheme to reduce power imbalance across symbols. The UE may generate UCI and may perform an allocation of the UCI as part of a multiplexing procedure for multiplexing the UCI with shared data for an uplink shared channel. For example, the UE may allocate the UCI to a set of resource elements associated with the uplink shared channel according to a time-first mapping scheme. Thus, the UE may transmit the uplink shared channel, including the UCI multiplexed with the shared data, based on the allocating. The time-first mapping scheme may be a time-first, frequency-next mapping scheme, where the UE may allocate the UCI to resource elements according to one or more rules.

### FIELD OF TECHNOLOGY

The following relates to wireless communications, including resource allocation of uplink control information on a shared channel.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a UE is described. The method may include generating uplink control information (UCI) associated with the UE, allocating, as part of a multiplexing procedure for multiplexing the UCI with shared data for an uplink shared channel, the UCI to a set of resource elements associated with the uplink shared channel according to a time-first mapping scheme, and transmitting the uplink shared channel including the UCI multiplexed with the shared data based on the allocating.

A UE for wireless communications is described. The UE may include one or more memories storing processor executable code, and one or more processors coupled with the one or more memories. The one or more processors may individually or collectively be operable to execute the code to cause the UE to generate UCI associated with the UE, allocate, as part of a multiplexing procedure for multiplexing the UCI with shared data for an uplink shared channel, the UCI to a set of resource elements associated with the uplink shared channel according to a time-first mapping scheme, and transmit the uplink shared channel including the UCI multiplexed with the shared data based on the allocating.

Another UE for wireless communications is described. The UE may include means for generating UCI associated with the UE, means for allocating, as part of a multiplexing procedure for multiplexing the UCI with shared data for an uplink shared channel, the UCI to a set of resource elements associated with the uplink shared channel according to a time-first mapping scheme, and means for transmitting the uplink shared channel including the UCI multiplexed with the shared data based on the allocating.

A non-transitory computer-readable medium storing code for wireless communications is described. The code may include instructions executable by one or more processors to generate UCI associated with the UE, allocate, as part of a multiplexing procedure for multiplexing the UCI with shared data for an uplink shared channel, the UCI to a set of resource elements associated with the uplink shared channel according to a time-first mapping scheme, and transmit the uplink shared channel including the UCI multiplexed with the shared data based on the allocating.

A method for wireless communications by a network entity is described. The method may include obtaining an uplink shared channel including UCI multiplexed with shared data and decoding, as part of a demultiplexing procedure for demultiplexing the UCI from the shared data of the uplink shared channel, the UCI from a set of resource elements associated with the uplink shared channel according to a time-first mapping scheme.

A network entity for wireless communications is described. The network entity may include one or more memories storing processor executable code, and one or more processors coupled with the one or more memories. The one or more processors may individually or collectively be operable to execute the code to cause the network entity to obtain an uplink shared channel including UCI multiplexed with shared data and decode, as part of a demultiplexing procedure for demultiplexing the UCI from the shared data of the uplink shared channel, the UCI from a set of resource elements associated with the uplink shared channel according to a time-first mapping scheme.

Another network entity for wireless communications is described. The network entity may include means for obtaining an uplink shared channel including UCI multiplexed with shared data and means for decoding, as part of a demultiplexing procedure for demultiplexing the UCI from the shared data of the uplink shared channel, the UCI from a set of resource elements associated with the uplink shared channel according to a time-first mapping scheme.

A non-transitory computer-readable medium storing code for wireless communications is described. The code may include instructions executable by one or more processors to obtain an uplink shared channel including UCI multiplexed with shared data and decode, as part of a demultiplexing procedure for demultiplexing the UCI from the shared data of the uplink shared channel, the UCI from a set of resource elements associated with the uplink shared channel according to a time-first mapping scheme.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports resource allocation of uplink control information (UCI) on a shared channel in accordance with one or more aspects of the present disclosure.

FIG. 2 shows an example of a wireless communications system that supports resource allocation of UCI on a shared channel in accordance with one or more aspects of the present disclosure.

FIGS. 3-6 each show a respective example of a resource mapping diagram that supports resource allocation of UCI on a shared channel in accordance with one or more aspects of the present disclosure.

FIG. 7 shows an example of a process flow that supports resource allocation of UCI on a shared channel in accordance with one or more aspects of the present disclosure.

FIGS. 8 and 9 show block diagrams of devices that support resource allocation of UCI on a shared channel in accordance with one or more aspects of the present disclosure.

FIG. 10 shows a block diagram of a communications manager that supports resource allocation of UCI on a shared channel in accordance with one or more aspects of the present disclosure.

FIG. 11 shows a diagram of a system including a device that supports resource allocation of UCI on a shared channel in accordance with one or more aspects of the present disclosure.

FIGS. 12 and 13 show block diagrams of devices that support resource allocation of UCI on a shared channel in accordance with one or more aspects of the present disclosure.

FIG. 14 shows a block diagram of a communications manager that supports resource allocation of UCI on a shared channel in accordance with one or more aspects of the present disclosure.

FIG. 15 shows a diagram of a system including a device that supports resource allocation of UCI on a shared channel in accordance with one or more aspects of the present disclosure.

FIGS. 16 through 20 show flowcharts illustrating methods that support resource allocation of UCI on a shared channel in accordance with one or more aspects of the present disclosure.

### DETAILED DESCRIPTION

A user equipment (UE) may multiplex uplink control information (UCI) (e.g., hybrid automatic repeat request acknowledgement (HARQ-ACK) information) with other shared information for a shared channel transmission. For example, a UE may place HARQ-ACK information in a resource element according to a rule relative to a resource element corresponding to a demodulation reference signal (DMRS).

A UE may allocate HARQ-ACK information to symbols with a time-first mapping scheme to reduce power imbalance across symbols. The UE may generate UCI (e.g., HARQ-ACKs) associated with the UE. Then, the UE may perform an allocation of the UCI as part of a multiplexing procedure for multiplexing the UCI with shared data for an uplink shared channel (e.g., a physical uplink shared channel (PUSCH)). For example, the UE may allocate the UCI to a set of resource elements associated with the uplink shared channel according to a time-first mapping scheme. Thus, the UE may transmit the uplink shared channel, including the UCI multiplexed with the shared data, based on the allocation. The time-first mapping scheme may be a time-first, frequency-next mapping scheme, where the UE may allocate the UCI to resource elements according to one or more rules. For example, the UE may place UCI symbols along a single subcarrier before moving on to a second subcarrier (Proposal A1). Additionally, or alternatively, the UE may place UCI symbols so that they are non-overlapping in the time domain and the frequency domain (Proposal A2). Another rule may include placing UCI symbols such that they are adjacent to DMRS symbols (e.g., on either side in the time domain), according to the time-first mapping scheme (Proposal B1). Lastly, the UE may place UCI symbols such that they are adjacent to DMRS symbols, but non-overlapping in the time domain and the frequency domain (Proposal B2).

Techniques described herein may reduce power imbalance across symbols within a shared channel transmission (e.g., when applying per-codeword power shaping techniques). Techniques described herein may further improve accuracy of channel estimation. This may result in increased communication reliability and reduced latency, among other advantages.

Aspects of the disclosure are initially described in the context of wireless communications systems. Aspects of the disclosure are then described in the context resource mapping diagrams and a process flow. Aspects of the disclosure are further illustrated by and described with reference to apparatus diagrams, system diagrams, and flowcharts that relate to resource allocation of UCI on a shared channel.

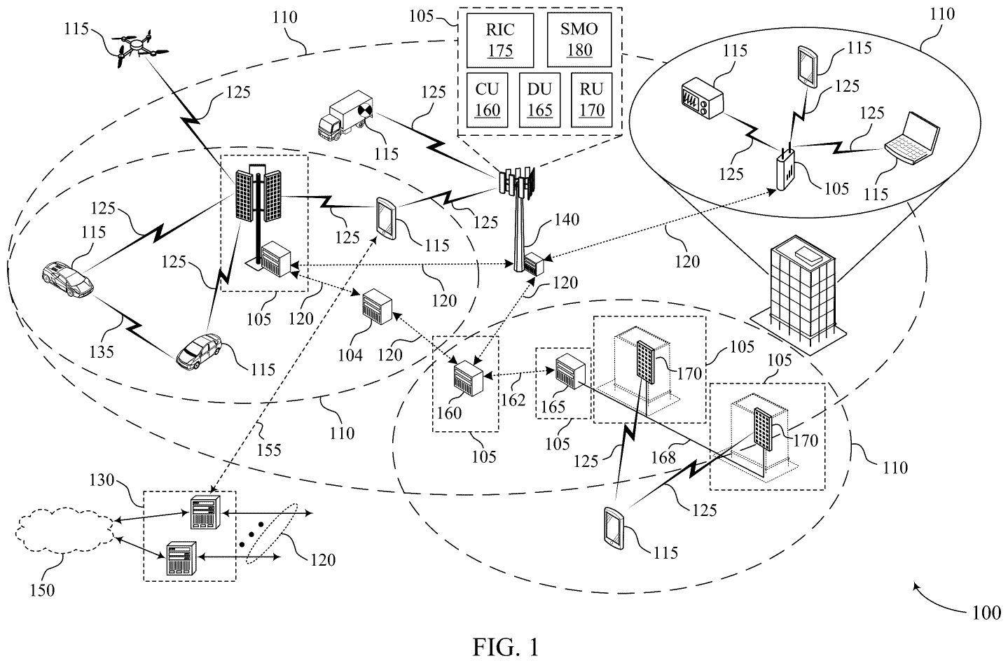

FIG. 1 shows an example of a wireless communications system 100 that supports resource allocation of UCI on a shared channel in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a UE may transmit HARQ-ACK bits through a physical uplink control channel (PUCCH) or a PUSCH. In some cases, if the UE multiplexes a set of coded HARQ-ACK bits onto a PUSCH, the UE may map the modulated HARQ-ACK symbols starting on a first available non-DMRS symbol after a first DMRS symbol within a set of resource elements (e.g., according to a time-frequency mapping). After all resource elements adjacent to DMRS in a given symbol (e.g., OFDM symbol) have been occupied, then the UE 115 may populate the resource elements adjacent to the next DMRS symbol. In some cases, PUSCH data and HARQ-ACK codewords may have equal-energy, and the UE 115 may refrain from applying a Power Shaping (PS) scheme. Thus, there may be relatively low power imbalance (e.g., power jump) across symbols within a PDSCH, irrespective of the resource allocation scheme used for the HARQ-ACK codewords.

In some cases, if the HARQ-ACK codewords each have a different per-codeword power, placing a HARQ-ACK codeword (or the coded symbols thereof) on a same symbol may lead to a relatively high power imbalance across symbols. For example, one resource element of a given symbol may carry the HARQ-ACK codeword, while a next symbol may carry PUSCH data. Thus, HARQ-ACK codewords may cause a power imbalance.

In some wireless communications systems, a UE may multiplex HARQ-ACK information for a shared channel transmission. For example, a UE may place HARQ-ACK information in a resource element adjacent to a resource element of a DMRS. That is, the UE may place the HARQ-ACK information in a symbol (e.g., an OFDM symbol) immediately after a DMRS symbol. If the UE determines to place more HARQ-ACK information, the UE may use a symbol adjacent to a second DMRS symbol, and so forth. However, placing HARQ-ACK information in a symbol as such may increase a power imbalance across symbols if each HARQ-ACK codeword is assigned a different power (e.g., due to a per-codeword power shaping procedure). For example, for each subcarrier within a frequency domain, there may be a power imbalance (e.g., a power jump) across a HARQ-ACK symbol in a time domain. This may result in reduced signal reliability and efficiency, diminishing the user experience. Thus, solutions which reduce such power imbalance across symbols are desirable.

Techniques described herein may reduce power imbalance across symbols within a shared channel transmission (e.g., when a HARQ-ACK codebook with power shaping is utilized to multiplex HARQ-ACK codewords onto the shared channel). The wireless communications system 100 may support a UE 115 that allocates HARQ-ACK information to symbols with a time-first mapping scheme to reduce power imbalance across symbols. The UE 115 may generate UCI (e.g., HARQ-ACKs) associated with the UE 115. Then, the UE 115 may perform an allocation of the UCI as part of a multiplexing procedure for multiplexing the UCI with shared data for an uplink shared channel (e.g., PUSCH). For example, the UE 115 may allocate the UCI to a set of resource elements associated with the uplink shared channel according to a time-first mapping scheme. Thus, the UE 115 may transmit the uplink shared channel, including the UCI multiplexed with the shared data, based on the allocation. The time-first mapping scheme may be a time-first, frequency-next mapping scheme, where the UE 115 may allocate the UCI to resource elements according to one or more rules. For example, the UE 115 may place UCI symbols along a single subcarrier before moving on to a second subcarrier (Proposal A1). Additionally, or alternatively, the UE 115 may place UCI symbols so that they are non-overlapping in the time domain and the frequency domain (Proposal A2). Another rule may include placing UCI symbols such that they are adjacent to DMRS symbols (e.g., on either side in the time domain), according to the time-first mapping scheme (Proposal B1). Lastly, the UE 115 may place UCI symbols such that they are adjacent to DMRS symbols, but non-overlapping in the time domain and the frequency domain (Proposal B2).

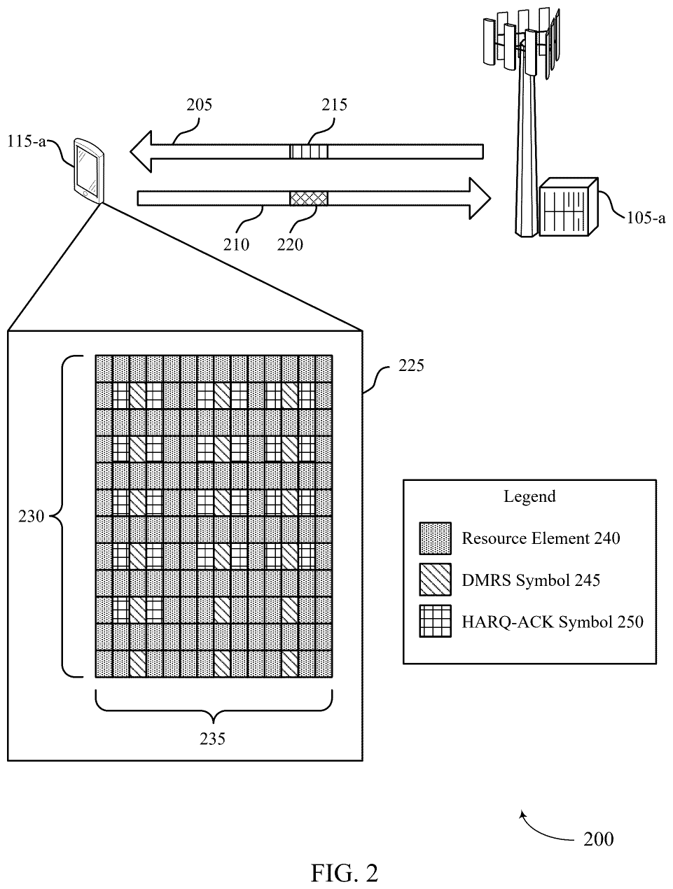

FIG. 2 shows an example of a wireless communications system 200 that supports resource allocation of UCI on a shared channel in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

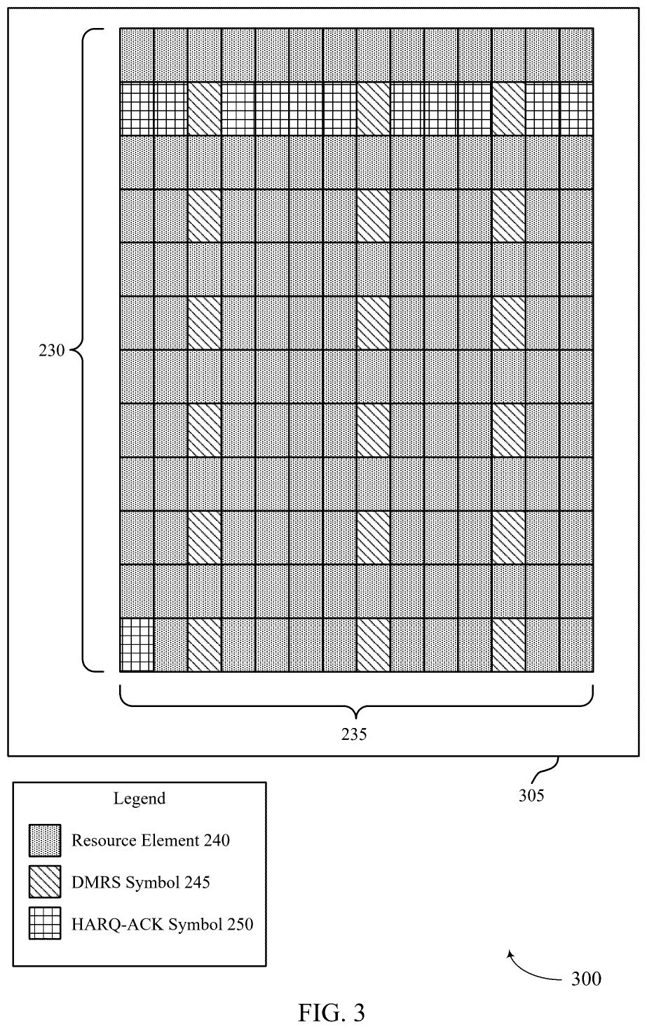

The UE 115-a may receive, from the network entity 105-a, one or more messages via a wireless communication link 205 (e.g., via a physical downlink shared channel (PDSCH) or a physical downlink control channel (PDCCH)). For example, the UE 115-a may receive a first message 215 that indicates at least one configuration associated with techniques as described herein. The at least one configuration may indicate a mapping scheme (e.g., as described with reference to FIGS. 3-6) that the UE 115-a is to use for transmitting UCI (e.g., HARQ-ACKs).

The UE 115-a may transmit, to the network entity 105-a, one or more messages via a wireless communication link 210 (e.g., via a PUSCH or a PUCCH). For example, the UE 115-a may prepare a second message 220 (e.g., a PUSCH transmission) by multiplexing UCI with other signaling (e.g., DMRS) according to a mapping scheme 225. Then, the UE 115-a may transmit a second message 220 (e.g., a PUSCH transmission) that includes the UCI multiplexed with the other signaling (e.g., data for the PUSCH).

The mapping scheme 225 may include a set of resource elements 240. As described herein, a resource element may refer to a slot, a symbol, (e.g., an OFDM symbol), or similar unit that subdivides a subcarrier within a time domain and that spans one frequency unit (e.g., subcarrier). The set of resource elements 240 may be arranged across a set of subcarriers 230 in a frequency domain and across a set of symbols 235 (e.g., OFDM symbols) in the time domain (e.g., in a slot) and may be grouped into resource blocks. Each resource element 240 of the set of resource elements 240 may include information or signaling (e.g., information of the second message 220). For example, the mapping scheme 225 may include one or more DMRS symbols 245, where each DMRS symbol 245 is allocated to a resource element 240 (e.g., by the UE 115-a). Further, the mapping scheme 225 may include one or more HARQ-ACK symbols 250, where each HARQ-ACK symbol 250 is allocated to a resource element 240 (e.g., by the UE 115-a).

FIGS. 3-6 each show a resource mapping diagram that illustrates an example of a mapping scheme that the UE 115-a may apply to allocate HARQ-ACK symbols 250 to resource elements 240. In the following description, although allocation procedures may refer specifically to HARQ-ACK symbols, the allocation procedures may also be applied for channel state information (CSI), scheduling request information, or similar information (e.g., information signaled in a PUSCH).

FIG. 3 shows an example of a resource mapping diagram 300 that supports resource allocation of UCI on a shared channel in accordance with one or more aspects of the present disclosure. Aspects of the resource mapping diagram 300 may implement or may be implemented by the wireless communications system 200. For example, the resource mapping diagram 300 may include a mapping scheme 305 (e.g., similar to the mapping scheme described with reference to FIG. 2). The mapping scheme 305 may include a set of resource elements 240. The set of resource elements 240 may span a set of subcarriers 230 in a frequency domain and across a set of symbols 235 (e.g., OFDM symbols) in a time domain (e.g., in a slot). Each resource element 240 of the set of resource elements 240 may include respective information or signaling. For example, the mapping scheme 305 may include one or more DMRS symbols 245, where each DMRS symbol 245 is allocated to a resource element 240 (e.g., by a UE 115). Further, the mapping scheme 305 may include one or more HARQ-ACK symbols 250, where each HARQ-ACK symbol 250 is allocated to a resource element 240 (e.g., by the UE 115).

In accordance with the mapping scheme 305, the UE 115 may allocate the one or more HARQ-ACK symbols 250 based on one or more rules. For example, the UE 115 may allocate a first HARQ-ACK symbol 250 to a first available resource element 240 within a first subcarrier. In some cases, the first subcarrier may include a DMRS symbol 245. In such cases, the first available resource element 240 may be non-overlapping (e.g., in a time domain) with the DMRS symbol 245. Then, the UE 115 may place (e.g., allocate) additional HARQ-ACK symbols 250 contiguously at each next available resource element 240 within the first subcarrier (e.g., in the time domain). In some examples, this may result in a subcarrier which has populated all available resource elements 240 with HARQ-ACK symbols 250 (e.g., as shown in FIG. 3).

After determining that all available resource elements 240 in the first subcarrier have been populated (e.g., after all resource elements 240 in a slot become unavailable), the UE 115 may repeat this procedure on a second subcarrier. That is, the UE 115 may allocate a first HARQ-ACK symbol 250 to a first available resource element 240 within a first subcarrier. Then, the UE 115 may place (e.g., allocate) additional HARQ-ACK symbols 250 contiguously at each next available resource element 240 within the second subcarrier (e.g., in the time domain). In some implementations, the UE 115-a may select subcarriers to be uniformly separated in a frequency domain (e.g., placing HARQ-ACK symbols 250 uniformly in frequency). This may result in relatively large gaps in frequency between HARQ-ACK resource elements on a same symbol (e.g., mitigating a power imbalance of HARQ-ACK symbols).

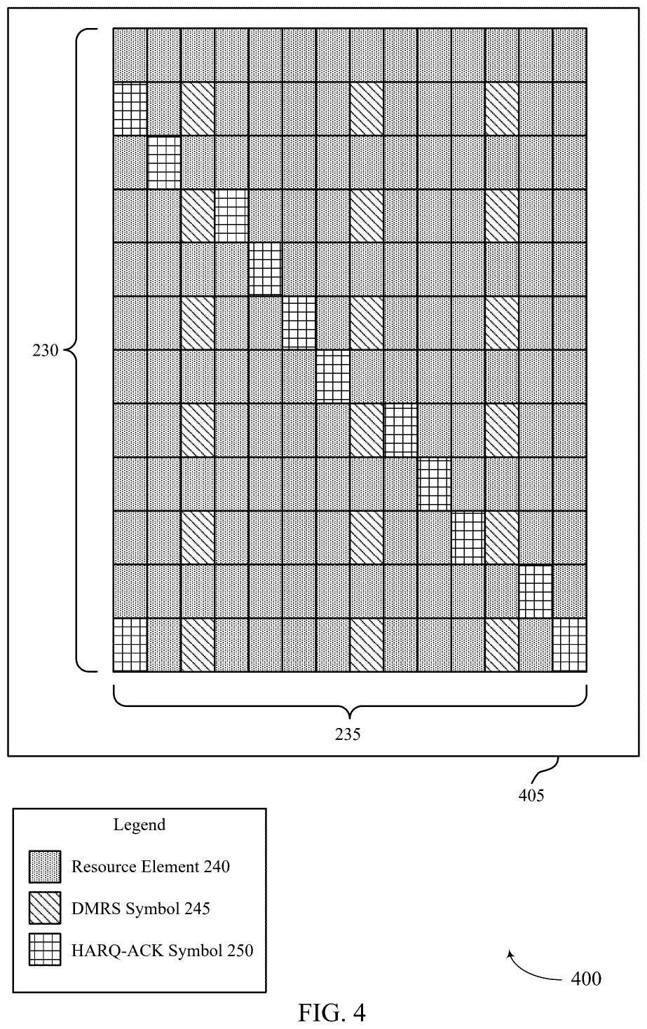

FIG. 4 shows an example of a resource mapping diagram 400 that supports resource allocation of UCI on a shared channel in accordance with one or more aspects of the present disclosure. Aspects of the resource mapping diagram 400 may implement or may be implemented by the wireless communications system 200. For example, the resource mapping diagram 400 may include a mapping scheme 405 (e.g., similar to the mapping scheme described with reference to FIG. 2). The mapping scheme 405 may include a set of resource elements 240. The set of resource elements 240 may be span a set of subcarriers 230 in a frequency domain and across a set of symbols 235 (e.g., OFDM symbols) in a time domain (e.g., in a slot). Each resource element 240 of the set of resource elements 240 may include respective information or signaling. For example, the mapping scheme 405 may include one or more DMRS symbols 245, where each DMRS symbol 245 is allocated to a resource element 240 (e.g., by a UE 115). Further, the mapping scheme 405 may include one or more HARQ-ACK symbols 250, where each HARQ-ACK symbol 250 is allocated to a resource element 240 (e.g., by the UE 115). In some cases, the mapping scheme 305 as described with reference to FIG. 3 may have relatively low frequency diversity. On the other hand, the mapping scheme 405 may increase frequency diversity by alternating between resource elements on different tones (e.g., subcarriers) before returning to a same tone.

In accordance with the mapping scheme 405, the UE 115 may allocate the one or more HARQ-ACK symbols 250 to respective resource elements 240 based on one or more rules. For example, the UE 115 may allocate a first HARQ-ACK symbol 250 of a first set to a first available resource element 240 within a first subcarrier (e.g., with an OFDM symbol index t₁ and subcarrier index f₁, represented as (t₁, f₁)). Then, the UE 115 may allocate a second HARQ-ACK symbol 250 of the first set to a second available resource element 240 within a second subcarrier. The UE 115 may select the second available resource element 240 such that it is non-overlapping (e.g., in the time domain) with the first available resource element 240 and non-overlapping with any DMRS symbol 245 (e.g., (t₂, f₂) such that t₂≠t₁ and f₂≠f₁ and non-overlapping with a DMRS). The UE 115 may similarly allocate subsequent HARQ-ACK symbols 250 of the first set (e.g., a third, a fourth, and so on) to respective resource elements 240, where each respective resource element 240 is within a respective (e.g., unique) subcarrier, is non-overlapping with any DMRS symbol 245, and is non-overlapping with other (e.g., previously allocated) HARQ-ACK symbols of the first set (e.g., identifying (t₃, f₃) such that t₃≠t₂≠t₁ and f₃≠f₂≠f₁ and non-overlapping with a DMRS).

After allocating each HARQ-ACK symbol 250 of the first set to respective resource elements 240 (e.g., once all such (tᵢ, fᵢ) combinations are exhausted), the UE 115 may similarly allocate each HARQ-ACK symbols 250 of a second set to respective resource elements 240 (e.g., using a same tᵢ or a same fᵢ for each selected resource element 240). For example, the UE 115 may allocate a first HARQ-ACK symbol 250 of the second set to a first available resource element 240 within a subcarrier that includes a HARQ-ACK symbol from the first set. In some cases, the first available resource element 240 may overlap (in a time domain) with a HARQ-ACK symbol 250 of the first set. The UE 115 may allocate subsequent HARQ-ACK symbols 250 of the second set to respective resource elements 240 accordingly, where each respective resource element 240 shares a subcarrier with a HARQ-ACK symbol 250 of the first set, and overlaps (in the time domain) with a HARQ-ACK symbol 250 of the first set. The UE 115 may allocate further sets of HARQ-ACK symbols 250 to respective resource elements 240 according to this pattern (e.g., such that each HARQ-ACK symbol 250 shares a subcarrier with (in the frequency domain) and overlaps with (in the time domain) one HARQ-ACK symbol 250 from each previous set).

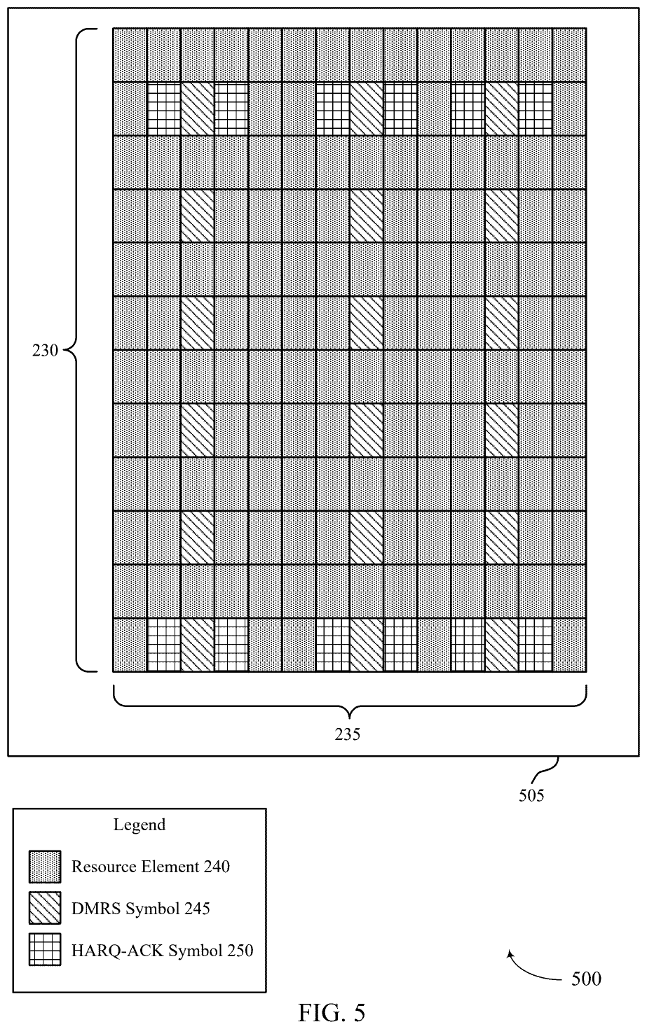

FIG. 5 shows an example of a resource mapping diagram 500 that supports resource allocation of UCI on a shared channel in accordance with one or more aspects of the present disclosure. Aspects of the resource mapping diagram 500 may implement or may be implemented by the wireless communications system 200. For example, the resource mapping diagram 500 may include a mapping scheme 505 (e.g., similar to the mapping scheme described with reference to FIG. 2). The mapping scheme 505 may include a set of resource elements 240. The set of resource elements 240 may be span a set of subcarriers 230 in a frequency domain and across a set of symbols 235 (e.g., OFDM symbols) in a time domain (e.g., in a slot). Each resource element 240 of the set of resource elements 240 may include respective information or signaling. For example, the mapping scheme 505 may include one or more DMRS symbols 245, where each DMRS symbol 245 is allocated to a resource element 240 (e.g., by a UE 115). Further, the mapping scheme 505 may include one or more HARQ-ACK symbols 250, where each HARQ-ACK symbol 250 is allocated to a resource element 240 (e.g., by the UE 115). In some implementations, the mapping scheme 505 may improve accuracy of a channel estimate used for equalization.

In accordance with the mapping scheme 505, the UE 115 may allocate the one or more HARQ-ACK symbols 250 to respective resource elements 240 based on one or more rules. For example, the UE 115 may allocate each HARQ-ACK symbol 250 of a first set to resource elements 240 that are adjacent to DMRS symbols 245 within a first subcarrier. That is, the UE 115 may allocate a first HARQ-ACK symbol 250 to a resource element 240 that immediately precedes a first DMRS symbol 245 within the first subcarrier (e.g., before the first DMRS symbol 245, in a time domain). Then, the UE 115 may allocate a second HARQ-ACK symbol 250 to a resource element 240 that immediately follows the first DMRS symbol 245 (e.g., after the first DMRS symbol 245, in the time domain). The UE 115 may thus allocate (e.g., place) subsequent HARQ-ACK symbols 250 to resource elements adjacent to respective DMRS symbols 245 (e.g., a second DMRS symbol 245, a third, and so on) within the first subcarrier. In some cases, the UE 115 may begin this pattern by allocating the first HARQ-ACK symbol to a first available resource element 240 that is adjacent to a DMRS symbol 245.

After determining that all resource elements 240 adjacent to DMRS symbols 245 within the first subcarrier are occupied (e.g., previously allocated), the UE 115 may select a second subcarrier, and may allocate additional HARQ-ACK symbols 250 to resource elements 240 that are adjacent to DMRS symbols 245 within the second subcarrier. Accordingly, the UE 115 may allocate HARQ-ACK symbols to resource elements 240 within additional available subcarriers (e.g., a third subcarrier, a fourth subcarrier, and so on). In some implementations, the UE 115 may allocate (e.g., place) HARQ-ACK symbols 250 uniformly in frequency (e.g., to achieve relatively large gaps in frequency between resource elements 240 that include HARQ-ACK symbols 250 on overlapping symbols within the time domain).

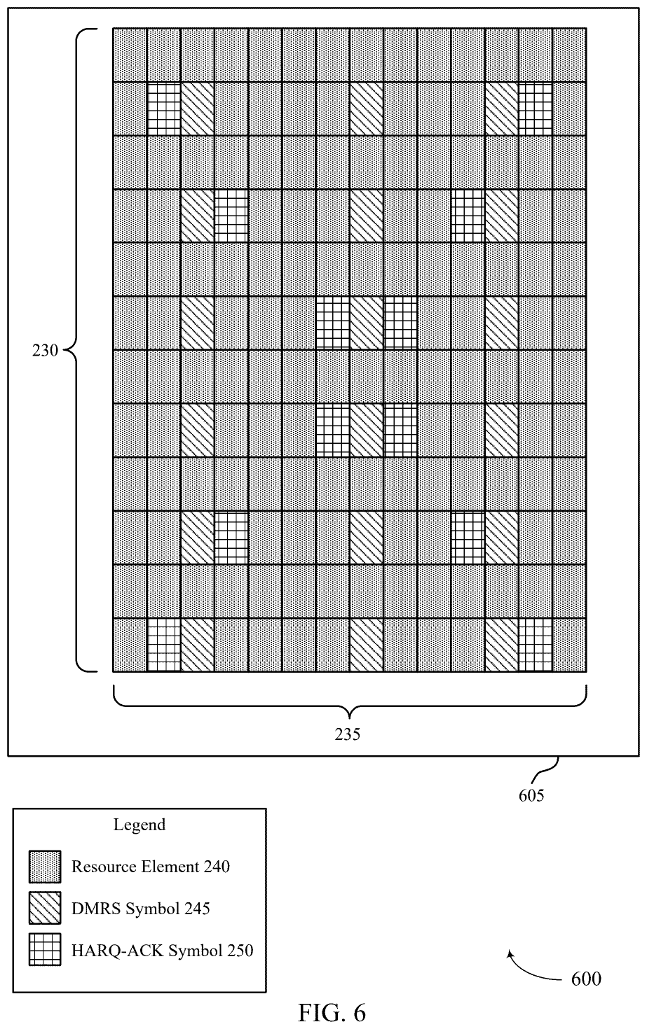

FIG. 6 shows an example of a resource mapping diagram 600 that supports resource allocation of UCI on a shared channel in accordance with one or more aspects of the present disclosure. Aspects of the resource mapping diagram 600 may implement or may be implemented by the wireless communications system 200. For example, the resource mapping diagram 600 may include a mapping scheme 605 (e.g., similar to the mapping scheme described with reference to FIG. 2). The mapping scheme 605 may include a set of resource elements 240. The set of resource elements 240 may span a set of subcarriers 230 in a frequency domain and across a set of symbols 235 (e.g., OFDM symbols) in a time domain (e.g., in a slot). Each resource element 240 of the set of resource elements 240 may include respective information or signaling. For example, the mapping scheme 605 may include one or more DMRS symbols 245, where each DMRS symbol 245 is allocated to a resource element 240 (e.g., by a UE 115). Further, the mapping scheme 605 may include one or more HARQ-ACK symbols 250, where each HARQ-ACK symbol 250 is allocated to a resource element 240 (e.g., by the UE 115). In some implementations, the mapping scheme 605 may improve frequency diversity and may improve accuracy of a channel estimate used for equalization. For example, the mapping scheme 605 may increase frequency diversity by alternating between resource elements on different tones (e.g., subcarriers) before returning to a same tone.

In accordance with the mapping scheme 605, the UE 115 may allocate the one or more HARQ-ACK symbols 250 to respective resource elements 240 based on one or more rules. For example, the UE 115 may allocate a first HARQ-ACK symbol 250 of a first set to a first available resource element 240 that is adjacent to a first DMRS symbol 245 within a first subcarrier (e.g., with an OFDM symbol index ty and subcarrier index f₁, represented as (t₁, f₁)). Then, the UE 115 may allocate a second HARQ-ACK symbol 250 of the first set to a second available resource element 240 adjacent to a DMRS symbol 245 within a second subcarrier. The UE 115 may select the second available resource element 240 such that it is non-overlapping (e.g., in the time domain) with the first available resource element 240 (e.g., (t₂, f₂) such that t₂≠t₁ and f₂≠f₁ and adjacent to a DMRS symbol 245). The UE 115 may similarly allocate subsequent HARQ-ACK symbols 250 of the first set (e.g., a third, a fourth, and so on) to respective resource elements 240, where each respective resource element 240 is within a respective (e.g., unique) subcarrier, is adjacent to a respective DMRS symbol 245, and is non-overlapping with other (e.g., previously allocated) HARQ-ACK symbols of the first set (e.g., identifying (t₃, f₃) such that t₃≠t₂≠t₁ and f₃≠f₂≠f₁).

After allocating each HARQ-ACK symbol 250 of the first set to respective resource elements 240 (e.g., once all such (tᵢ, fᵢ) combinations are exhausted), the UE 115 may similarly allocate each HARQ-ACK symbols 250 of a second set to respective resource elements 240 (e.g., using a same tᵢ or a same fᵢ for each selected resource element 240). For example, the UE 115 may allocate a first HARQ-ACK symbol 250 of the second set to a first available resource element 240 adjacent to a DMRS symbol 245 within a subcarrier that includes a HARQ-ACK symbol from the first set. In some cases, the first available resource element 240 may overlap (in a time domain) with a HARQ-ACK symbol 250 of the first set. The UE 115 may allocate subsequent HARQ-ACK symbols 250 of the second set to respective resource elements 240 accordingly, where each respective resource element 240 shares a subcarrier with a HARQ-ACK symbol 250 of the first set, overlaps (in the time domain) with a HARQ-ACK symbol 250 of the first set, and is adjacent to a respective DMRS symbol 245 within the subcarrier. The UE 115 may allocate further sets of HARQ-ACK symbols 250 to respective resource elements 240 according to this pattern (e.g., such that each HARQ-ACK symbol 250 is adjacent to a DMRS symbol 245 and shares a subcarrier with (in the frequency domain) and overlaps with (in the time domain) one HARQ-ACK symbol 250 from each previous set).

In some implementations, the UE 115 may select a mapping scheme of a set of mapping schemes based on a configuration of the UE 115, based on one or more conditions being met, based on a quantity of HARQ-ACK symbols 250 to be allocated, or any combination thereof. The set of mapping schemes may include the mapping schemes described with reference to FIGS. 3-6 (e.g., the mapping scheme 305, the mapping scheme 405, the mapping scheme 505, and the mapping scheme 605). The mapping scheme 505 and the mapping scheme 605 may include a similar quantity of overlapping HARQ-ACK symbols 250 in each symbol (e.g., a same quantity of coded symbols in each OFDM symbol) adjacent to a DMRS symbol 245 (e.g., two). On the other hand, the mapping scheme 305 and the mapping scheme 405 may include a similar quantity of HARQ-ACK symbols 250 in each symbol (e.g., one). Thus, the UE 115 may select the mapping scheme 305 or the mapping scheme 405 to achieve a relatively lower power jump across symbols. The UE 115 may select the mapping scheme 505 or the mapping scheme 605 to achieve relatively higher accurate channel estimates.

The UE 115 may select a mapping scheme from the set of mapping schemes if a quantity of HARQ-ACK symbols 250 relative to a total quantity of resource elements 240 (e.g., non-DMRS PUSCH resource elements) satisfies a threshold. For example, if a ratio of HARQ-ACK symbols 250 to total resource elements 240 is below the threshold (e.g., ratio=0.01), the UE 115 may refrain from selecting any mapping scheme of the set of mapping schemes (e.g., selecting a different mapping scheme). If the ratio is above the threshold (e.g., ratio=0.2), the UE 115 may allocate HARQ-ACK symbols 250 according to a mapping scheme of the set of mapping schemes. In some cases, the UE 115 may receive signaling (e.g., from a network entity 105 via RRC, MAC-CE, or both) that indicates that the UE 115 is to select a particular mapping scheme, a particular multiplexing option, or both. The UE 115 may receive the signaling dynamically or semi-statically.

Although the techniques described herein discuss allocation of HARQ-ACK information or symbols, the techniques are also applicable for other types of UCI. In some implementations, the UE 115 may multiplex different types of UCI data on a same PUSCH (e.g., HARQ-ACK, CSI, or scheduling request information). Each type of UCI data may be associated with a different resource allocation scheme (e.g., a different mapping scheme). For example, the UE 115 may encode each type of UCI separately (e.g., using per-codeword power shaping or otherwise). That is, each type may not include a power jump across OFDM symbols. Thus, in some cases, the UE 115 may allocate UCI according to a mapping scheme of the set of mapping schemes if the UCI is associated with a power shaping procedure (e.g., if the UE 115 generated the UCI according to a per-codeword power shaping procedure). In some implementations, the techniques described herein may be applied for one or more transmit waveform types. For example, the techniques may be applied for both DFT-S-OFDM and cyclic prefix-OFDM (CP-OFDM) based transmit waveforms.

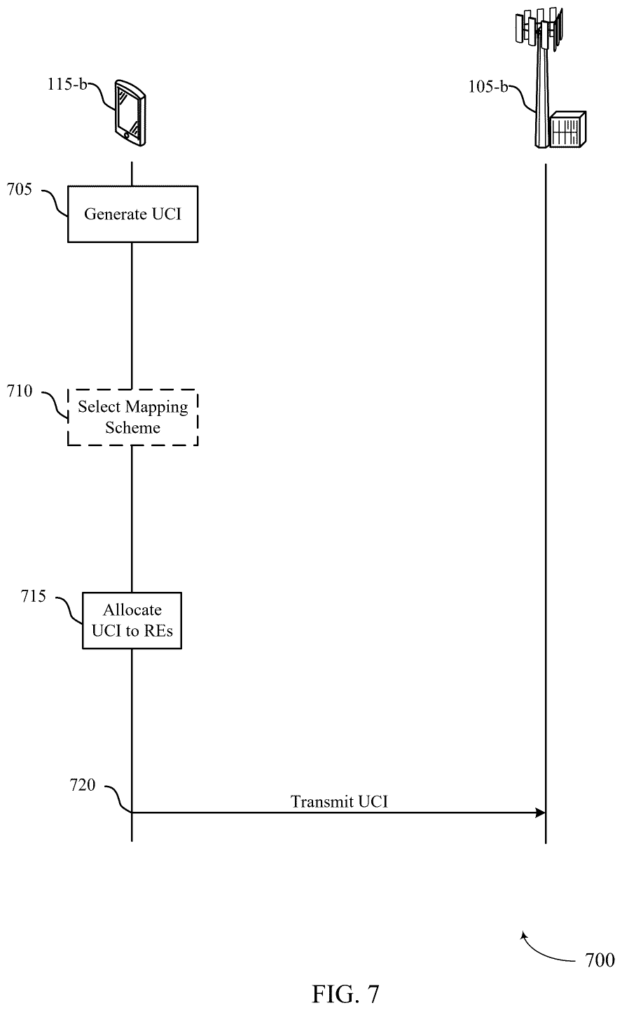

FIG. 7 shows an example of a process flow 700 that supports resource allocation of UCI on a shared channel in accordance with one or more aspects of the present disclosure. The process flow 700 includes a UE 115-b and a network entity 105-b, which may be examples of the corresponding devices as described with respect to FIGS. 1-6. In the following description of the process flow 700, the operations between the UE 115-b and the network entity 105-b may be performed in a different order than the example order shown. Some operations may also be omitted from the process flow 700, and other operations may be added to the process flow 700. Further, although some operations or signaling may be shown to occur at different times for discussion purposes, these operations may actually occur at the same time.

At 705, the UE 115-b may generate UCI (e.g., HARQ-ACK information) associated with the UE 115-b. In some cases, the UE 115-b may perform a per-codeword power shaping procedure in accordance with generation of the UCI, a multiplexing procedure associated with the UCI, transmission of the UCI, or any combination thereof.

At 710, the UE 115-b may optionally select a mapping scheme for allocating the UCI to respective resource elements. In some cases, the UE 115-b may select the mapping scheme from a set of mapping schemes (e.g., as described with reference to FIGS. 3-6). In some examples, the UE 115-b may select the mapping scheme based on a quantity or a percentage of HARQ-ACK information in the UCI satisfying a threshold.

At 715, the UE 115-b may allocate the UCI to a set of resource elements associated with an uplink shared channel (e.g., a PUSCH) according to a time-first mapping scheme. In some cases, the UE 115-b may allocate the UCI as part of the multiplexing procedure for multiplexing the UCI with shared data for the uplink shared channel. The UE 115-b may allocate the UCI according to the time-first mapping scheme based on whether a per-codeword power shaping procedure is used to transmit the UCI.

In some examples, the UE 115-b may allocate a set of first portions of the UCI to a first group of resource elements that share a first subcarrier. The UE 115-b may allocate the set of first portions within the first subcarrier and across multiple symbols according to the time-first mapping scheme. In some cases, the UE 115-b may allocate, based on the first subcarrier being devoid of available resource elements, a set of second portions of the UCI to a second group of resource elements that share a second subcarrier. The UE 115-b may allocate the set of second portions within the second subcarrier and across at least a portion of the multiple symbols according to the time-first mapping scheme.

In some examples, the UE 115-b may allocate each portion of a first set of portions of the UCI to respective first resource elements on non-overlapping subcarriers in a frequency-domain and non-overlapping slots in a time-domain. In some cases, the UE 115-b may allocate each portion of a second set of portions of the UCI to respective second resource elements. The UE 115-b may allocate each respective second resource element to a same subcarrier as a respective first resource element and to a different slot than the respective first resource element.

In some examples, the UE 115-b may allocate each portion of a first set of portions of the UCI to respective first adjacent resource elements that are adjacent, in a time domain, to respective third resource elements that are for reference signaling (e.g., DMRS symbols). The UE 115-b may allocate the first set of portions within a first subcarrier according to the time-first mapping scheme. In some cases, the UE 115-b may allocate, based on allocating to all first adjacent resource elements, each portion of a second set of portions of the UCI to respective second adjacent resource elements that are adjacent, in the time domain, to respective fourth resource elements that are for reference signal information (e.g., DMRS symbols). The UE 115-b may allocate the second set of portions within a second subcarrier according to the time-first mapping scheme.

In some examples, the UE 115-b may allocate each portion of a first set of portions of the UCI to respective first resource elements that are adjacent, in a time domain, to respective third resource elements that are for reference signal information. The respective first resource elements may be on non-overlapping subcarriers in a frequency-domain and in non-overlapping slots in a time-domain. In some cases, the UE 115-b may allocate each portion of a second set of portions of the UCI to respective second resource elements that are adjacent, in the time domain, to respective fourth resource elements that are for reference signal information. The respective second resource elements may be on second non-overlapping subcarriers in the frequency-domain and in second non-overlapping slots in the time-domain. The UE 115-b may allocate each respective second resource element to a same subcarrier as a respective first resource element and to a different slot than the respective first resource element.

At 720, the UE 115-b may transmit the UCI, including the UCI multiplexed with the shared data based on the allocating. In some cases, the UE 115-b may transmit the UCI according to an OFDM based transmit waveform. In some examples, the UCI may include one or more of HARQ-ACK information, CSI, or scheduling request information.

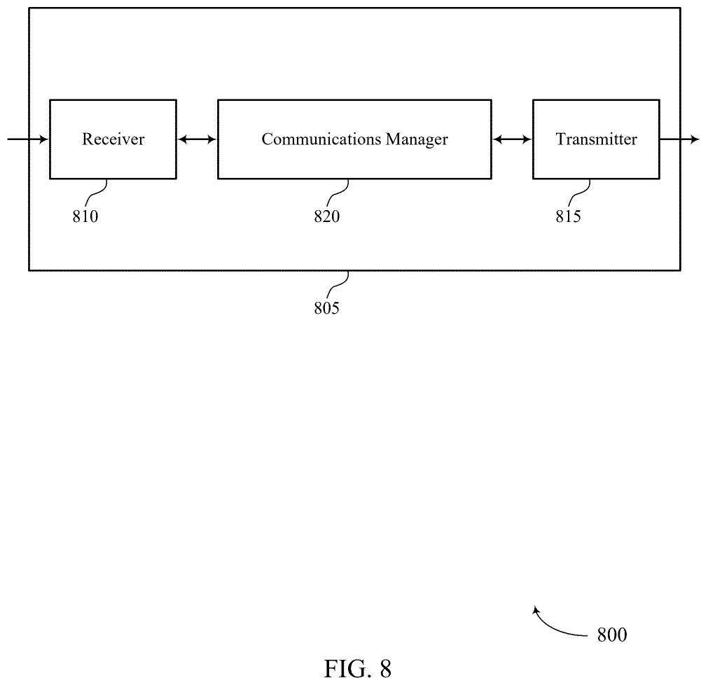

FIG. 8 shows a block diagram 800 of a device 805 that supports resource allocation of UCI on a shared channel in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to resource allocation of UCI on a shared channel). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to resource allocation of UCI on a shared channel). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of resource allocation of UCI on a shared channel as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for generating UCI associated with the UE. The communications manager 820 is capable of, configured to, or operable to support a means for allocating, as part of a multiplexing procedure for multiplexing the UCI with shared data for an uplink shared channel, the UCI to a set of resource elements associated with the uplink shared channel according to a time-first mapping scheme. The communications manager 820 is capable of, configured to, or operable to support a means for transmitting the uplink shared channel including the UCI multiplexed with the shared data based on the allocating.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for resource allocation of UCI on a shared channel, which may result in reduced power consumption and more efficient utilization of communication resources, among other advantages.

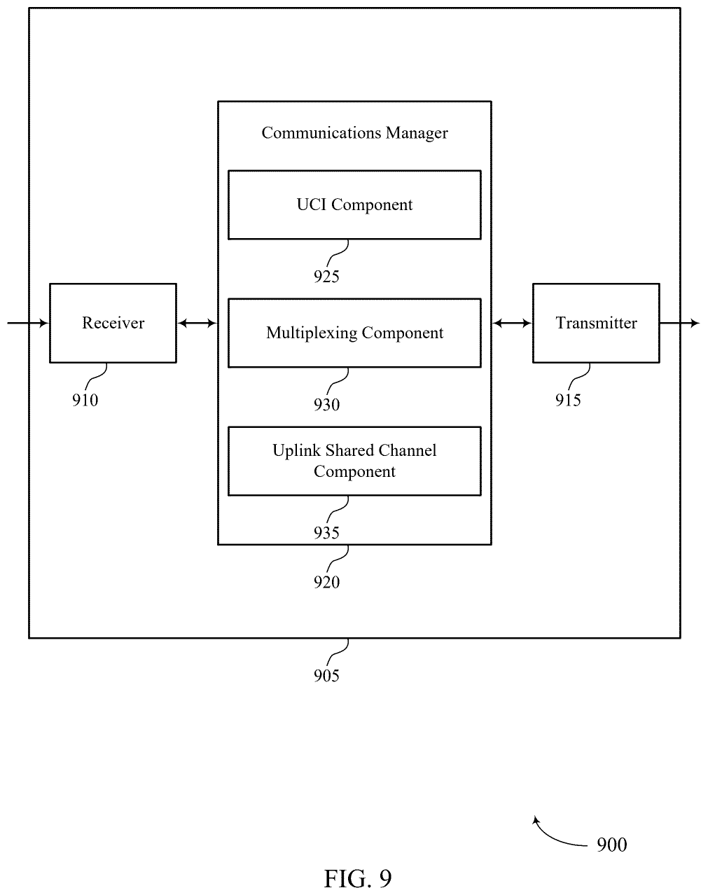

FIG. 9 shows a block diagram 900 of a device 905 that supports resource allocation of UCI on a shared channel in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to resource allocation of UCI on a shared channel). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to resource allocation of UCI on a shared channel). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of resource allocation of UCI on a shared channel as described herein. For example, the communications manager 920 may include a UCI component 925, a multiplexing component 930, an uplink shared channel component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The UCI component 925 is capable of, configured to, or operable to support a means for generating UCI associated with the UE. The multiplexing component 930 is capable of, configured to, or operable to support a means for allocating, as part of a multiplexing procedure for multiplexing the UCI with shared data for an uplink shared channel, the UCI to a set of resource elements associated with the uplink shared channel according to a time-first mapping scheme. The uplink shared channel component 935 is capable of, configured to, or operable to support a means for transmitting the uplink shared channel including the UCI multiplexed with the shared data based on the allocating.

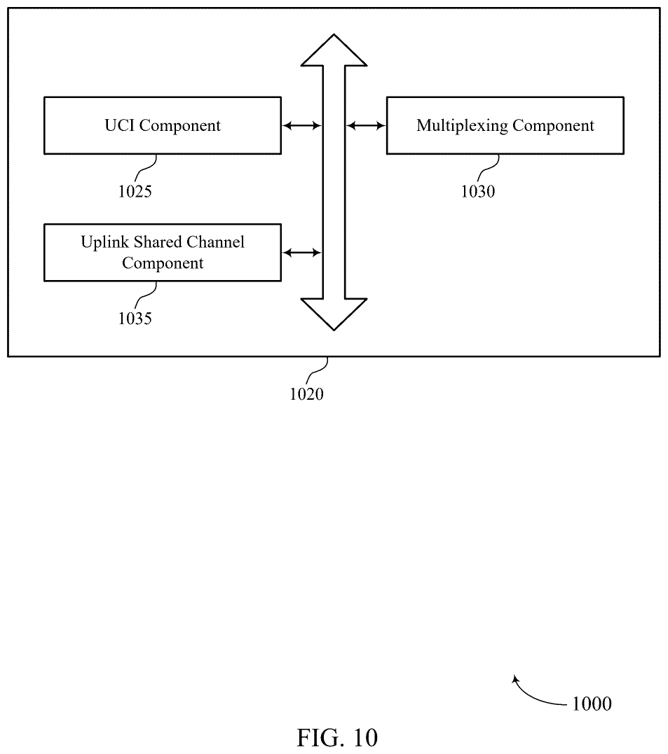

FIG. 10 shows a block diagram 1000 of a communications manager 1020 that supports resource allocation of UCI on a shared channel in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of resource allocation of UCI on a shared channel as described herein. For example, the communications manager 1020 may include a UCI component 1025, a multiplexing component 1030, an uplink shared channel component 1035, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The UCI component 1025 is capable of, configured to, or operable to support a means for generating UCI associated with the UE. The multiplexing component 1030 is capable of, configured to, or operable to support a means for allocating, as part of a multiplexing procedure for multiplexing the UCI with shared data for an uplink shared channel, the UCI to a set of resource elements associated with the uplink shared channel according to a time-first mapping scheme. The uplink shared channel component 1035 is capable of, configured to, or operable to support a means for transmitting the uplink shared channel including the UCI multiplexed with the shared data based on the allocating.

In some examples, to support allocating the UCI to the set of resource elements, the multiplexing component 1030 is capable of, configured to, or operable to support a means for allocating a set of first portions of the UCI to a first group of resource elements that share a first subcarrier, where the set of first portions are allocated within the first subcarrier and across a set of multiple symbols according to the time-first mapping scheme.

In some examples, to support allocating the UCI to the set of resource elements, the multiplexing component 1030 is capable of, configured to, or operable to support a means for allocating, based on the first subcarrier being devoid of available resource elements, a set of second portions of the UCI to a second group of resource elements that share a second subcarrier, where the set of second portions are allocated within the second subcarrier and across at least a portion of the set of multiple symbols according to the time-first mapping scheme.

In some examples, to support allocating the UCI to the set of resource elements, the multiplexing component 1030 is capable of, configured to, or operable to support a means for allocating each portion of a first set of portions of the UCI to respective first resource elements on non-overlapping subcarriers in a frequency-domain and non-overlapping slots in a time-domain.

In some examples, to support allocating the UCI to the set of resource elements, the multiplexing component 1030 is capable of, configured to, or operable to support a means for allocating each portion of a second set of portions of the UCI to respective second resource elements, where each respective second resource element is allocated to a same subcarrier as a respective first resource element and is allocated to a different slot than the respective first resource element.

In some examples, to support allocating the UCI to the set of resource elements, the multiplexing component 1030 is capable of, configured to, or operable to support a means for allocating each portion of a first set of portions of the UCI to respective first adjacent resource elements that are adjacent, in a time domain, to respective third resource elements that are for reference signaling, where the first set of portions are allocated within a first subcarrier according to the time-first mapping scheme.

In some examples, to support allocating the UCI to the set of resource elements, the multiplexing component 1030 is capable of, configured to, or operable to support a means for allocating, based on allocating to all first adjacent resource elements, each portion of a second set of portions of the UCI to respective second adjacent resource elements that are adjacent, in the time domain, to respective fourth resource elements that are for reference signal information, where the second set of portions are allocated within a second subcarrier according to the time-first mapping scheme.

In some examples, to support allocating the UCI to the set of resource elements, the multiplexing component 1030 is capable of, configured to, or operable to support a means for allocating each portion of a first set of portions of the UCI to respective first resource elements that are adjacent, in a time domain, to respective third resource elements that are for reference signal information, where the respective first resource elements are on non-overlapping subcarriers in a frequency-domain and in non-overlapping slots in a time-domain.

In some examples, to support allocating the UCI to the set of resource elements, the multiplexing component 1030 is capable of, configured to, or operable to support a means for allocating each portion of a second set of portions of the UCI to respective second resource elements that are adjacent, in the time domain, to respective fourth resource elements that are for reference signal information, where the respective second resource elements are on second non-overlapping subcarriers in the frequency-domain and in second non-overlapping slots in the time-domain, and where each respective second resource element is allocated to a same subcarrier as a respective first resource element and is allocated to a different slot than the respective first resource element.

In some examples, to support allocating the UCI, the multiplexing component 1030 is capable of, configured to, or operable to support a means for allocating the UCI according to the time-first mapping scheme based on whether a per-codeword power shaping procedure is used to transmit the UCI.

In some examples, to support allocating the UCI, the multiplexing component 1030 is capable of, configured to, or operable to support a means for allocating HARQ-ACK information.

In some examples, allocating the UCI according to the time-first mapping scheme is based on a quantity or a percentage of HARQ-ACK information in the UCI satisfying a threshold.

In some examples, to support transmitting the uplink shared channel, the UCI component 1025 is capable of, configured to, or operable to support a means for transmitting the uplink shared channel according to an orthogonal frequency division multiplexing based transmit waveform.

In some examples, the UCI includes one or more of CSI or scheduling request information.

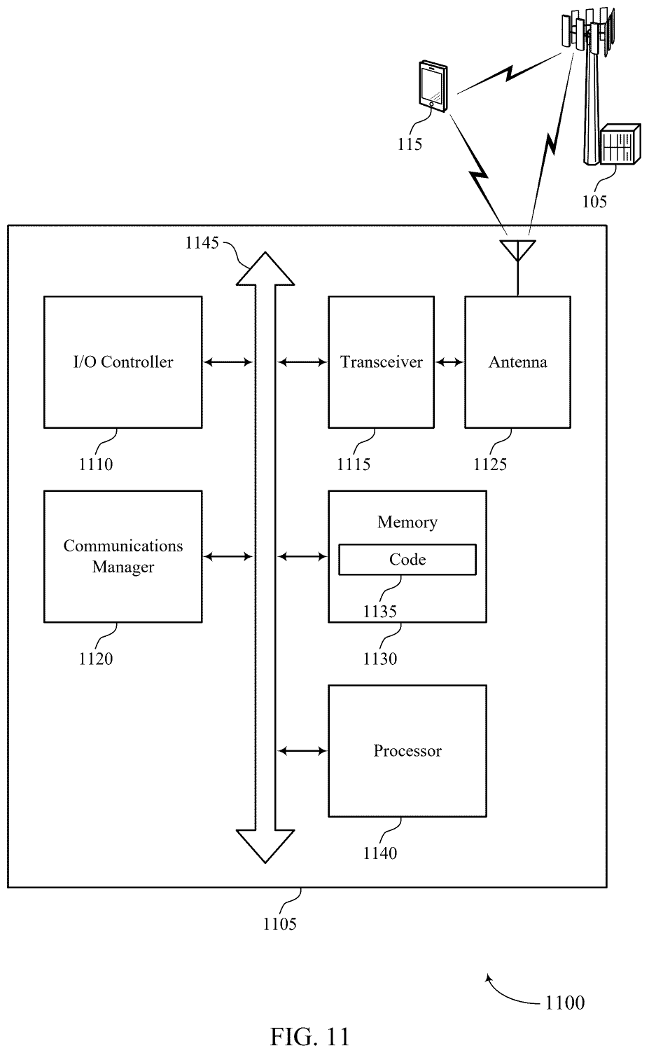

FIG. 11 shows a diagram of a system 1100 including a device 1105 that supports resource allocation of UCI on a shared channel in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting resource allocation of UCI on a shared channel). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for generating UCI associated with the UE. The communications manager 1120 is capable of, configured to, or operable to support a means for allocating, as part of a multiplexing procedure for multiplexing the UCI with shared data for an uplink shared channel, the UCI to a set of resource elements associated with the uplink shared channel according to a time-first mapping scheme. The communications manager 1120 is capable of, configured to, or operable to support a means for transmitting the uplink shared channel including the UCI multiplexed with the shared data based on the allocating.

By including or configuring the communications manager 1120 in accordance with examples as described herein, the device 1105 may support techniques for resource allocation of UCI on a shared channel, which may result in improved communication reliability, reduced latency, reduced power consumption, more efficient utilization of communication resources, improved coordination between devices, and improved utilization of processing capability, among other advantages.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of resource allocation of UCI on a shared channel as described herein, or the at least one processor 1140 and the at least one memory 1130 may be otherwise configured to, individually or collectively, perform or support such operations.

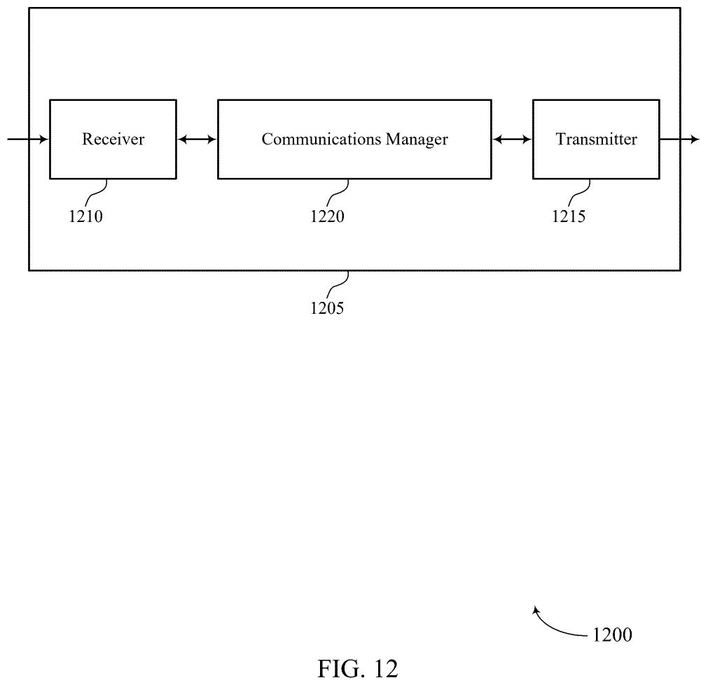

FIG. 12 shows a block diagram 1200 of a device 1205 that supports resource allocation of UCI on a shared channel in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of resource allocation of UCI on a shared channel as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for obtaining an uplink shared channel including UCI multiplexed with shared data. The communications manager 1220 is capable of, configured to, or operable to support a means for decoding, as part of a demultiplexing procedure for demultiplexing the UCI from the shared data of the uplink shared channel, the UCI from a set of resource elements associated with the uplink shared channel according to a time-first mapping scheme.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for resource allocation of UCI on a shared channel, which may result in reduced power consumption and more efficient utilization of communication resources, among other advantages.

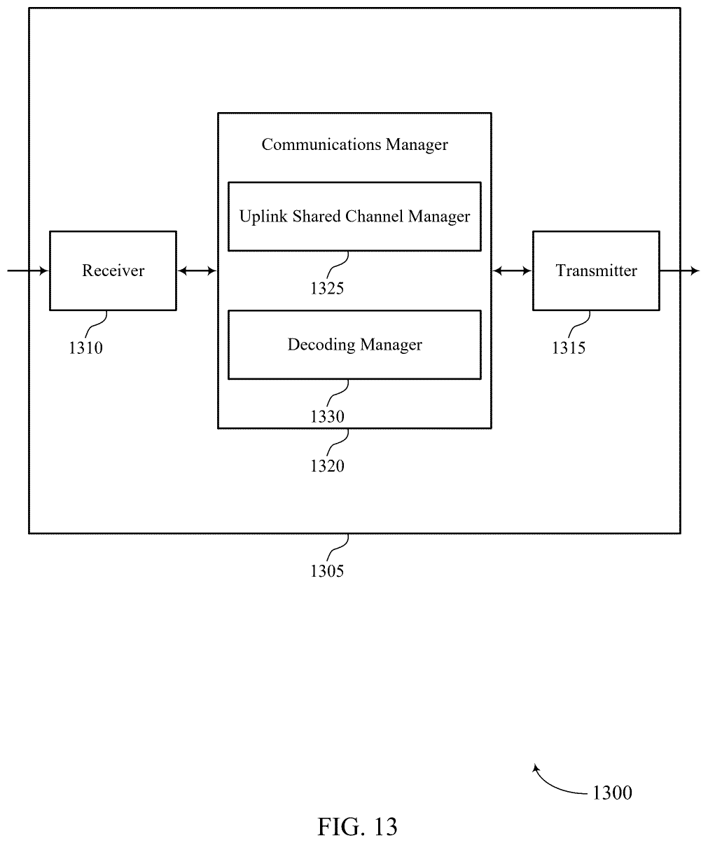

FIG. 13 shows a block diagram 1300 of a device 1305 that supports resource allocation of UCI on a shared channel in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of resource allocation of UCI on a shared channel as described herein. For example, the communications manager 1320 may include an uplink shared channel manager 1325 a decoding manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The uplink shared channel manager 1325 is capable of, configured to, or operable to support a means for obtaining an uplink shared channel including UCI multiplexed with shared data. The decoding manager 1330 is capable of, configured to, or operable to support a means for decoding, as part of a demultiplexing procedure for demultiplexing the UCI from the shared data of the uplink shared channel, the UCI from a set of resource elements associated with the uplink shared channel according to a time-first mapping scheme.

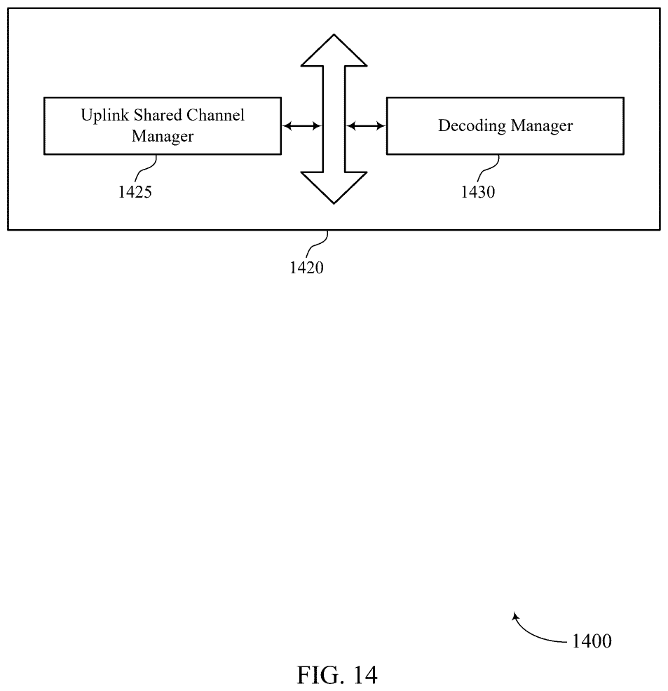

FIG. 14 shows a block diagram 1400 of a communications manager 1420 that supports resource allocation of UCI on a shared channel in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of resource allocation of UCI on a shared channel as described herein. For example, the communications manager 1420 may include an uplink shared channel manager 1425 a decoding manager 1430, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The uplink shared channel manager 1425 is capable of, configured to, or operable to support a means for obtaining an uplink shared channel including UCI multiplexed with shared data. The decoding manager 1430 is capable of, configured to, or operable to support a means for decoding, as part of a demultiplexing procedure for demultiplexing the UCI from the shared data of the uplink shared channel, the UCI from a set of resource elements associated with the uplink shared channel according to a time-first mapping scheme.

In some examples, to support decoding the UCI from the set of resource elements, the decoding manager 1430 is capable of, configured to, or operable to support a means for decoding a set of first portions of the UCI from a first group of resource elements that share a first subcarrier, where the set of first portions are distributed on the first subcarrier and across a set of multiple symbols according to the time-first mapping scheme.

In some examples, to support decoding the UCI from the set of resource elements, the decoding manager 1430 is capable of, configured to, or operable to support a means for decoding, based on the first subcarrier being devoid of available resource elements, a set of second portions of the UCI from a second group of resource elements that share a second subcarrier, where the set of second portions are distributed within the second subcarrier and across at least a portion of the set of multiple symbols according to the time-first mapping scheme.

In some examples, to support decoding the UCI from the set of resource elements, the decoding manager 1430 is capable of, configured to, or operable to support a means for decoding each portion of a first set of portions of the UCI from respective first resource elements on non-overlapping subcarriers in a frequency-domain and non-overlapping slots in a time-domain.

In some examples, to support decoding the UCI from the set of resource elements, the decoding manager 1430 is capable of, configured to, or operable to support a means for decoding each portion of a second set of portions of the UCI from respective second resource elements, where each respective second resource element is decoded from a same subcarrier as a respective first resource element and is decoded from a different slot than the respective first resource element.

In some examples, to support decoding the UCI from the set of resource elements, the decoding manager 1430 is capable of, configured to, or operable to support a means for decoding each portion of a first set of portions of the UCI from respective first adjacent resource elements that are adjacent, in a time domain, to respective third resource elements that are for reference signaling, where the first set of portions are distributed within a first subcarrier according to the time-first mapping scheme.

In some examples, to support decoding the UCI from the set of resource elements, the decoding manager 1430 is capable of, configured to, or operable to support a means for decoding, based on decoding from all first adjacent resource elements, each portion of a second set of portions of the UCI from respective second adjacent resource elements that are adjacent, in the time domain, to respective fourth resource elements that are for reference signal information, where the second set of portions are distributed within a second subcarrier according to the time-first mapping scheme.

In some examples, to support decoding the UCI from the set of resource elements, the decoding manager 1430 is capable of, configured to, or operable to support a means for decoding each portion of a first set of portions of the UCI from respective first resource elements that are adjacent, in a time domain, to respective third resource elements that are for reference signal information, where the respective first resource elements are on non-overlapping subcarriers in a frequency-domain and in non-overlapping slots in a time-domain.

In some examples, to support decoding the UCI from the set of resource elements, the decoding manager 1430 is capable of, configured to, or operable to support a means for decoding each portion of a second set of portions of the UCI from respective second resource elements that are adjacent, in the time domain, to respective fourth resource elements that are for reference signal information, where the respective second resource elements are on second non-overlapping subcarriers in the frequency-domain and in second non-overlapping slots in the time-domain, and where each respective second resource element is decoded from a same subcarrier as a respective first resource element and is decoded from a different slot than the respective first resource element.

In some examples, to support decoding the UCI, the decoding manager 1430 is capable of, configured to, or operable to support a means for decoding the UCI according to the time-first mapping scheme based on whether a per-codeword power shaping procedure is used to transmit the UCI.

In some examples, to support decoding the UCI, the decoding manager 1430 is capable of, configured to, or operable to support a means for decoding HARQ-ACK acknowledgement information.

In some examples, decoding the UCI according to the time-first mapping scheme is based on a quantity or a percentage of HARQ-ACK acknowledgement information in the UCI satisfying a threshold.

In some examples, to support obtaining the uplink shared channel, the decoding manager 1430 is capable of, configured to, or operable to support a means for obtaining the uplink shared channel according to an orthogonal frequency division multiplexing based transmit waveform.

In some examples, the UCI includes one or more of CSI or scheduling request information.

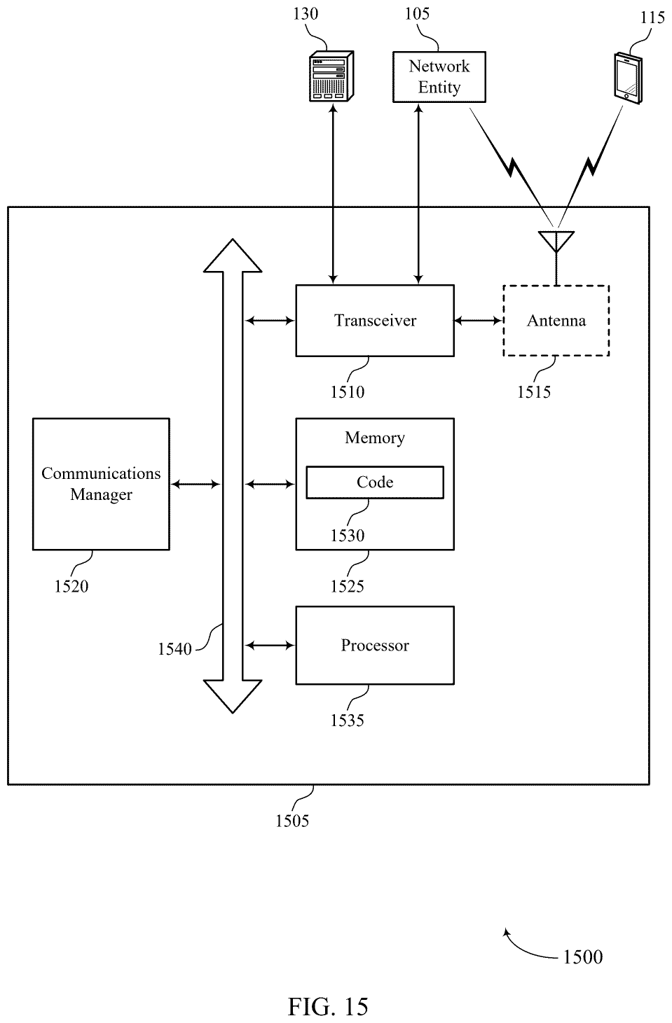

FIG. 15 shows a diagram of a system 1500 including a device 1505 that supports resource allocation of UCI on a shared channel in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting resource allocation of UCI on a shared channel). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for obtaining an uplink shared channel including UCI multiplexed with shared data. The communications manager 1520 is capable of, configured to, or operable to support a means for decoding, as part of a demultiplexing procedure for demultiplexing the UCI from the shared data of the uplink shared channel, the UCI from a set of resource elements associated with the uplink shared channel according to a time-first mapping scheme.

By including or configuring the communications manager 1520 in accordance with examples as described herein, the device 1505 may support techniques for resource allocation of UCI on a shared channel, which may result in improved communication reliability, reduced latency, reduced power consumption, more efficient utilization of communication resources, improved coordination between devices, and improved utilization of processing capability, among other advantages.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of resource allocation of UCI on a shared channel as described herein, or the at least one processor 1535 and the at least one memory 1525 may be otherwise configured to, individually or collectively, perform or support such operations.

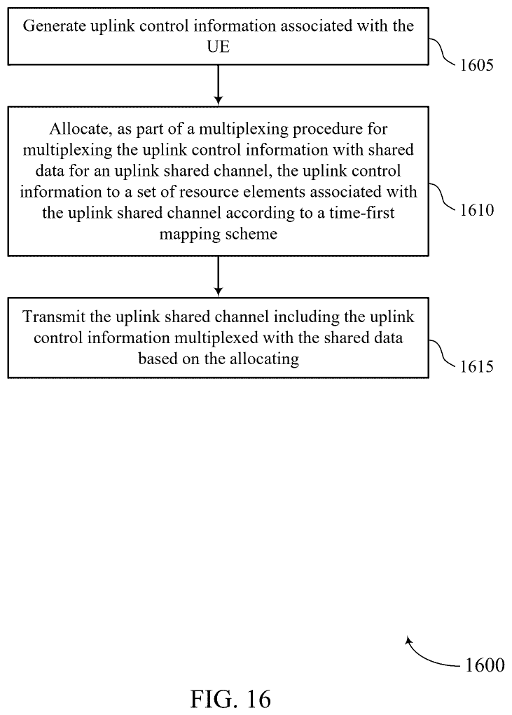

FIG. 16 shows a flowchart illustrating a method 1600 that supports resource allocation of UCI on a shared channel in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include generating UCI associated with the UE. The operations of 1605 may be performed in accordance with examples as disclosed herein. In some examples, aspects of the operations of 1605 may be performed by a UCI component 1025 as described with reference to FIG. 10.

At 1610, the method may include allocating, as part of a multiplexing procedure for multiplexing the UCI with shared data for an uplink shared channel, the UCI to a set of resource elements associated with the uplink shared channel according to a time-first mapping scheme. The operations of 1610 may be performed in accordance with examples as disclosed herein. In some examples, aspects of the operations of 1610 may be performed by a multiplexing component 1030 as described with reference to FIG. 10.

At 1615, the method may include transmitting the uplink shared channel including the UCI multiplexed with the shared data based on the allocating. The operations of 1615 may be performed in accordance with examples as disclosed herein. In some examples, aspects of the operations of 1615 may be performed by an uplink shared channel component 1035 as described with reference to FIG. 10.

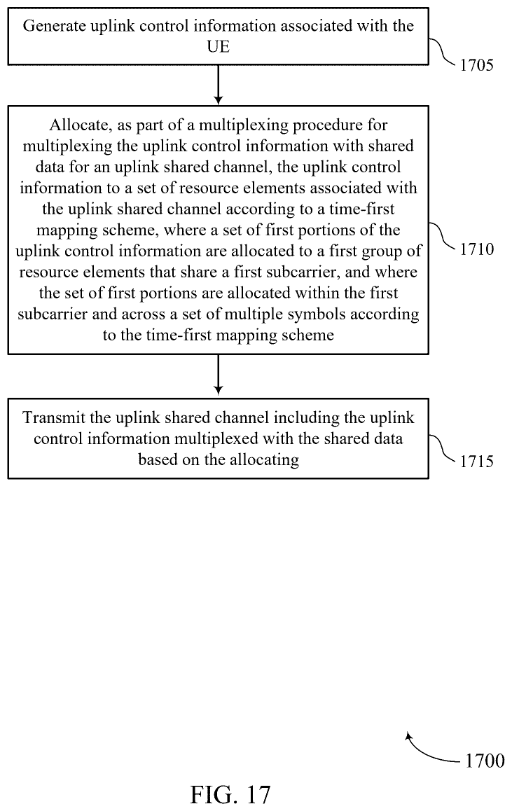

FIG. 17 shows a flowchart illustrating a method 1700 that supports resource allocation of UCI on a shared channel in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include generating UCI associated with the UE. The operations of 1705 may be performed in accordance with examples as disclosed herein. In some examples, aspects of the operations of 1705 may be performed by a UCI component 1025 as described with reference to FIG. 10.

At 1710, the method may include allocating, as part of a multiplexing procedure for multiplexing the UCI with shared data for an uplink shared channel, the UCI to a set of resource elements associated with the uplink shared channel according to a time-first mapping scheme, where a set of first portions of the UCI are allocated to a first group of resource elements that share a first subcarrier, and where the set of first portions are allocated within the first subcarrier and across a set of multiple symbols according to the time-first mapping scheme. The operations of 1710 may be performed in accordance with examples as disclosed herein. In some examples, aspects of the operations of 1710 may be performed by a multiplexing component 1030 as described with reference to FIG. 10.

At 1715, the method may include transmitting the uplink shared channel including the UCI multiplexed with the shared data based on the allocating. The operations of 1715 may be performed in accordance with examples as disclosed herein. In some examples, aspects of the operations of 1715 may be performed by an uplink shared channel component 1035 as described with reference to FIG. 10.

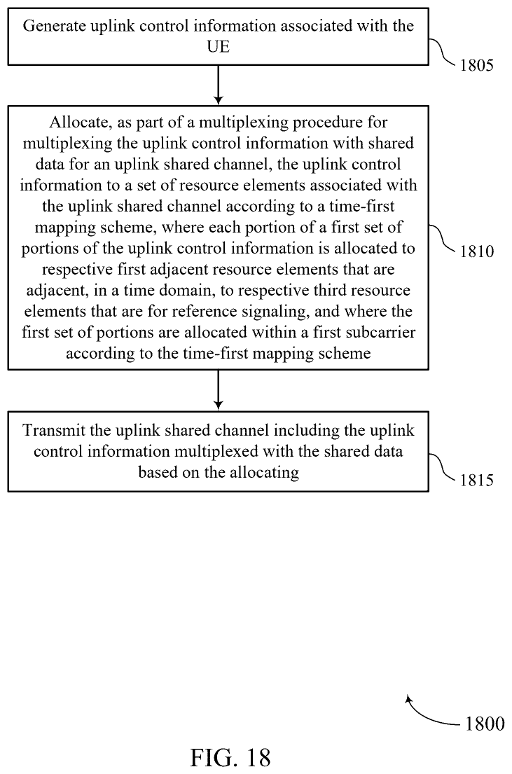

FIG. 18 shows a flowchart illustrating a method 1800 that supports resource allocation of UCI on a shared channel in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include generating UCI associated with the UE. The operations of 1805 may be performed in accordance with examples as disclosed herein. In some examples, aspects of the operations of 1805 may be performed by a UCI component 1025 as described with reference to FIG. 10.

At 1810, the method may include allocating, as part of a multiplexing procedure for multiplexing the UCI with shared data for an uplink shared channel, the UCI to a set of resource elements associated with the uplink shared channel according to a time-first mapping scheme, where each portion of a first set of portions of the UCI is allocated to respective first adjacent resource elements that are adjacent, in a time domain, to respective third resource elements that are for reference signaling, and where the first set of portions are allocated within a first subcarrier according to the time-first mapping scheme. The operations of 1810 may be performed in accordance with examples as disclosed herein. In some examples, aspects of the operations of 1810 may be performed by a multiplexing component 1030 as described with reference to FIG. 10.

At 1815, the method may include transmitting the uplink shared channel including the UCI multiplexed with the shared data based on the allocating. The operations of 1815 may be performed in accordance with examples as disclosed herein. In some examples, aspects of the operations of 1815 may be performed by an uplink shared channel component 1035 as described with reference to FIG. 10.

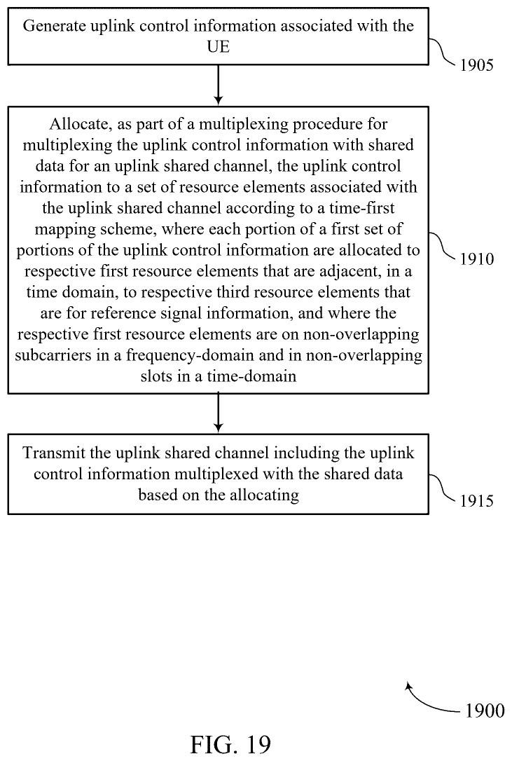

FIG. 19 shows a flowchart illustrating a method 1900 that supports resource allocation of UCI on a shared channel in accordance with one or more aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1905, the method may include generating UCI associated with the UE. The operations of 1905 may be performed in accordance with examples as disclosed herein. In some examples, aspects of the operations of 1905 may be performed by a UCI component 1025 as described with reference to FIG. 10.

At 1910, the method may include allocating, as part of a multiplexing procedure for multiplexing the UCI with shared data for an uplink shared channel, the UCI to a set of resource elements associated with the uplink shared channel according to a time-first mapping scheme, where each portion of a first set of portions of the UCI are allocated to respective first resource elements that are adjacent, in a time domain, to respective third resource elements that are for reference signal information, and where the respective first resource elements are on non-overlapping subcarriers in a frequency-domain and in non-overlapping slots in a time-domain. The operations of 1910 may be performed in accordance with examples as disclosed herein. In some examples, aspects of the operations of 1910 may be performed by a multiplexing component 1030 as described with reference to FIG. 10.

At 1915, the method may include transmitting the uplink shared channel including the UCI multiplexed with the shared data based on the allocating. The operations of 1915 may be performed in accordance with examples as disclosed herein. In some examples, aspects of the operations of 1915 may be performed by an uplink shared channel component 1035 as described with reference to FIG. 10.

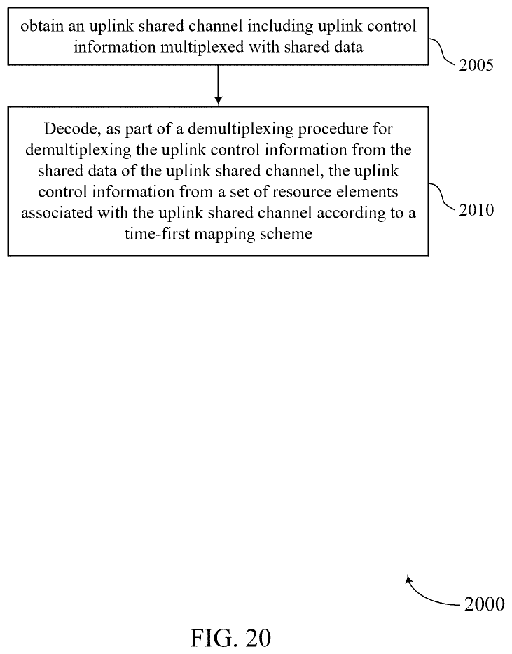

FIG. 20 shows a flowchart illustrating a method 2000 that supports resource allocation of UCI on a shared channel in accordance with one or more aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include obtaining an uplink shared channel including UCI multiplexed with shared data. The operations of 2005 may be performed in accordance with examples as disclosed herein. In some examples, aspects of the operations of 2005 may be performed by an uplink shared channel manager 1425 as described with reference to FIG. 14.

At 2010, the method may include decoding, as part of a demultiplexing procedure for demultiplexing the UCI from the shared data of the uplink shared channel, the UCI from a set of resource elements associated with the uplink shared channel according to a time-first mapping scheme. The operations of 2010 may be performed in accordance with examples as disclosed herein. In some examples, aspects of the operations of 2010 may be performed by a decoding manager 1430 as described with reference to FIG. 14.

The following provides an overview of aspects of the present disclosure:

Aspect 1: A method for wireless communications at a UE, comprising: generating UCI associated with the UE; allocating, as part of a multiplexing procedure for multiplexing the UCI with shared data for an uplink shared channel, the UCI to a set of resource elements associated with the uplink shared channel according to a time-first mapping scheme; and transmitting the uplink shared channel comprising the UCI multiplexed with the shared data based at least in part on the allocating.

Aspect 2: The method of aspect 1, wherein allocating the UCI to the set of resource elements comprises: allocating a set of first portions of the UCI to a first group of resource elements that share a first subcarrier, wherein the set of first portions are allocated within the first subcarrier and across a plurality of symbols according to the time-first mapping scheme.

Aspect 3: The method of aspect 2, wherein allocating the UCI to the set of resource elements comprises: allocating, based at least in part on the first subcarrier being devoid of available resource elements, a set of second portions of the UCI to a second group of resource elements that share a second subcarrier, wherein the set of second portions are allocated within the second subcarrier and across at least a portion of the plurality of symbols according to the time-first mapping scheme.

Aspect 4: The method of any of aspects 1 through 3, wherein allocating the UCI to the set of resource elements comprises: allocating each portion of a first set of portions of the UCI to respective first resource elements on non-overlapping subcarriers in a frequency-domain and non-overlapping slots in a time-domain.

Aspect 5: The method of aspect 4, wherein allocating the UCI to the set of resource elements comprises: allocating each portion of a second set of portions of the UCI to respective second resource elements, wherein each respective second resource element is allocated to a same subcarrier as a respective first resource element and is allocated to a different slot than the respective first resource element.

Aspect 6: The method of any of aspects 1 through 5, wherein allocating the UCI to the set of resource elements comprises: allocating each portion of a first set of portions of the UCI to respective first adjacent resource elements that are adjacent, in a time domain, to respective third resource elements that are for reference signaling, wherein the first set of portions are allocated within a first subcarrier according to the time-first mapping scheme.

Aspect 7: The method of aspect 6, wherein allocating the UCI to the set of resource elements comprises: allocating, based at least in part on allocating to all first adjacent resource elements, each portion of a second set of portions of the UCI to respective second adjacent resource elements that are adjacent, in the time domain, to respective fourth resource elements that are for reference signal information, wherein the second set of portions are allocated within a second subcarrier according to the time-first mapping scheme.

Aspect 8: The method of any of aspects 1 through 7, wherein allocating the UCI to the set of resource elements comprises: allocating each portion of a first set of portions of the UCI to respective first resource elements that are adjacent, in a time domain, to respective third resource elements that are for reference signal information, wherein the respective first resource elements are on non-overlapping subcarriers in a frequency-domain and in non-overlapping slots in a time-domain.

Aspect 9: The method of aspect 8, wherein allocating the UCI to the set of resource elements comprises: allocating each portion of a second set of portions of the UCI to respective second resource elements that are adjacent, in the time domain, to respective fourth resource elements that are for reference signal information, wherein the respective second resource elements are on second non-overlapping subcarriers in the frequency-domain and in second non-overlapping slots in the time-domain, and wherein each respective second resource element is allocated to a same subcarrier as a respective first resource element and is allocated to a different slot than the respective first resource element.

Aspect 10: The method of any of aspects 1 through 9, wherein allocating the UCI comprises: allocating the UCI according to the time-first mapping scheme based at least in part on whether a per-codeword power shaping procedure is used to transmit the UCI.

Aspect 11: The method of any of aspects 1 through 10, wherein allocating the UCI comprises: allocating HARQ-ACK information.

Aspect 12: The method of aspect 11, wherein allocating the UCI according to the time-first mapping scheme is based at least in part on a quantity or a percentage of HARQ-ACK information in the UCI satisfying a threshold.

Aspect 13: The method of any of aspects 1 through 12, wherein transmitting the uplink shared channel comprises: transmitting the uplink shared channel according to an orthogonal frequency division multiplexing based transmit waveform.

Aspect 14: The method of any of aspects 1 through 13, wherein the UCI comprises one or more of CSI or scheduling request information.

Aspect 15: A method for wireless communications at a network entity, comprising: obtaining an uplink shared channel comprising UCI multiplexed with shared data; and decoding, as part of a demultiplexing procedure for demultiplexing the UCI from the shared data of the uplink shared channel, the UCI from a set of resource elements associated with the uplink shared channel according to a time-first mapping scheme.

Aspect 16: The method of aspect 15, wherein decoding the UCI from the set of resource elements comprises: decoding a set of first portions of the UCI from a first group of resource elements that share a first subcarrier, wherein the set of first portions are distributed on the first subcarrier and across a plurality of symbols according to the time-first mapping scheme.

Aspect 17: The method of aspect 16, wherein decoding the UCI from the set of resource elements comprises: decoding, based at least in part on the first subcarrier being devoid of available resource elements, a set of second portions of the UCI from a second group of resource elements that share a second subcarrier, wherein the set of second portions are distributed within the second subcarrier and across at least a portion of the plurality of symbols according to the time-first mapping scheme.

Aspect 18: The method of any of aspects 15 through 17, wherein decoding the UCI from the set of resource elements comprises: decoding each portion of a first set of portions of the UCI from respective first resource elements on non-overlapping subcarriers in a frequency-domain and non-overlapping slots in a time-domain.

Aspect 19: The method of aspect 18, wherein decoding the UCI from the set of resource elements comprises: decoding each portion of a second set of portions of the UCI from respective second resource elements, wherein each respective second resource element is decoded from a same subcarrier as a respective first resource element and is decoded from a different slot than the respective first resource element.

Aspect 20: The method of any of aspects 15 through 19, wherein decoding the UCI from the set of resource elements comprises: decoding each portion of a first set of portions of the UCI from respective first adjacent resource elements that are adjacent, in a time domain, to respective third resource elements that are for reference signaling, wherein the first set of portions are distributed within a first subcarrier according to the time-first mapping scheme.

Aspect 21: The method of aspect 20, wherein decoding the UCI from the set of resource elements comprises: decoding, based at least in part on decoding from all first adjacent resource elements, each portion of a second set of portions of the UCI from respective second adjacent resource elements that are adjacent, in the time domain, to respective fourth resource elements that are for reference signal information, wherein the second set of portions are distributed within a second subcarrier according to the time-first mapping scheme.

Aspect 22: The method of any of aspects 15 through 21, wherein decoding the UCI from the set of resource elements comprises: decoding each portion of a first set of portions of the UCI from respective first resource elements that are adjacent, in a time domain, to respective third resource elements that are for reference signal information, wherein the respective first resource elements are on non-overlapping subcarriers in a frequency-domain and in non-overlapping slots in a time-domain.

Aspect 23: The method of aspect 22, wherein decoding the UCI from the set of resource elements comprises: decoding each portion of a second set of portions of the UCI from respective second resource elements that are adjacent, in the time domain, to respective fourth resource elements that are for reference signal information, wherein the respective second resource elements are on second non-overlapping subcarriers in the frequency-domain and in second non-overlapping slots in the time-domain, and wherein each respective second resource element is decoded from a same subcarrier as a respective first resource element and is decoded from a different slot than the respective first resource element.

Aspect 24: The method of any of aspects 15 through 23, wherein decoding the UCI comprises: decoding the UCI according to the time-first mapping scheme based at least in part on whether a per-codeword power shaping procedure is used to transmit the UCI.

Aspect 25: The method of any of aspects 15 through 24, wherein decoding the UCI comprises: decoding HARQ-ACK information.

Aspect 26: The method of aspect 25, wherein decoding the UCI according to the time-first mapping scheme is based at least in part on a quantity or a percentage of HARQ-ACK information in the UCI satisfying a threshold.

Aspect 27: The method of any of aspects 15 through 26, wherein obtaining the uplink shared channel comprises: obtaining the uplink shared channel according to an orthogonal frequency division multiplexing based transmit waveform.

Aspect 28: The method of any of aspects 15 through 27, wherein the UCI comprises one or more of CSI or scheduling request information.

Aspect 29: A UE for wireless communications, comprising one or more memories storing processor-executable code, and one or more processors coupled with the one or more memories and individually or collectively operable to execute the code to cause the UE to perform a method of any of aspects 1 through 14.

Aspect 30: A UE for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A network entity for wireless communications, comprising one or more memories storing processor-executable code, and one or more processors coupled with the one or more memories and individually or collectively operable to execute the code to cause the network entity to perform a method of any of aspects 15 through 28.

Aspect 33: A network entity for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
generate uplink control information associated with the UE;
allocate, as part of a multiplexing procedure for multiplexing the uplink control information with shared data for an uplink shared channel, the uplink control information to a set of resource elements associated with the uplink shared channel according to a time-first mapping scheme; and
transmit the uplink shared channel comprising the uplink control information multiplexed with the shared data based at least in part on the allocating.

2. The UE of claim 1, wherein, to allocate the uplink control information to the set of resource elements, the one or more processors are individually or collectively operable to execute the code to cause the UE to:
allocate a set of first portions of the uplink control information to a first group of resource elements that share a first subcarrier, wherein the set of first portions are allocated within the first subcarrier and across a plurality of symbols according to the time-first mapping scheme.

3. The UE of claim 2, wherein, to allocate the uplink control information to the set of resource elements, the one or more processors are individually or collectively operable to execute the code to cause the UE to:
allocate, based at least in part on the first subcarrier being devoid of available resource elements, a set of second portions of the uplink control information to a second group of resource elements that share a second subcarrier, wherein the set of second portions are allocated within the second subcarrier and across at least a portion of the plurality of symbols according to the time-first mapping scheme.

4. The UE of claim 1, wherein, to allocate the uplink control information to the set of resource elements, the one or more processors are individually or collectively operable to execute the code to cause the UE to:
allocate each portion of a first set of portions of the uplink control information to respective first resource elements on non-overlapping subcarriers in a frequency-domain and non-overlapping slots in a time-domain.

5. The UE of claim 4, wherein, to allocate the uplink control information to the set of resource elements, the one or more processors are individually or collectively operable to execute the code to cause the UE to:
allocate each portion of a second set of portions of the uplink control information to respective second resource elements, wherein each respective second resource element is allocated to a same subcarrier as a respective first resource element and is allocated to a different slot than the respective first resource element.

6. The UE of claim 1, wherein, to allocate the uplink control information to the set of resource elements, the one or more processors are individually or collectively operable to execute the code to cause the UE to:
allocate each portion of a first set of portions of the uplink control information to respective first adjacent resource elements that are adjacent, in a time domain, to respective third resource elements that are for reference signaling, wherein the first set of portions are allocated within a first subcarrier according to the time-first mapping scheme.

7. The UE of claim 6, wherein, to allocate the uplink control information to the set of resource elements, the one or more processors are individually or collectively operable to execute the code to cause the UE to:
allocate, based at least in part on allocating to all first adjacent resource elements, each portion of a second set of portions of the uplink control information to respective second adjacent resource elements that are adjacent, in the time domain, to respective fourth resource elements that are for reference signal information, wherein the second set of portions are allocated within a second subcarrier according to the time-first mapping scheme.

8. The UE of claim 1, wherein, to allocate the uplink control information to the set of resource elements, the one or more processors are individually or collectively operable to execute the code to cause the UE to:
allocate each portion of a first set of portions of the uplink control information to respective first resource elements that are adjacent, in a time domain, to respective third resource elements that are for reference signal information, wherein the respective first resource elements are on non-overlapping subcarriers in a frequency-domain and in non-overlapping slots in a time-domain.

9. The UE of claim 8, wherein, to allocate the uplink control information to the set of resource elements, the one or more processors are individually or collectively operable to execute the code to cause the UE to:
allocate each portion of a second set of portions of the uplink control information to respective second resource elements that are adjacent, in the time domain, to respective fourth resource elements that are for reference signal information, wherein the respective second resource elements are on second non-overlapping subcarriers in the frequency-domain and in second non-overlapping slots in the time-domain, and wherein each respective second resource element is allocated to a same subcarrier as a respective first resource element and is allocated to a different slot than the respective first resource element.

10. The UE of claim 1, wherein, to allocate the uplink control information, the one or more processors are individually or collectively operable to execute the code to cause the UE to:
allocate the uplink control information according to the time-first mapping scheme based at least in part on whether a per-codeword power shaping procedure is used to transmit the uplink control information.

11. The UE of claim 1, wherein, to allocate the uplink control information, the one or more processors are individually or collectively operable to execute the code to cause the UE to:
allocate hybrid automatic repeat request acknowledgement information.

12. The UE of claim 11, wherein allocating the uplink control information according to the time-first mapping scheme is based at least in part on a quantity or a percentage of hybrid automatic repeat request acknowledgement information in the uplink control information satisfying a threshold.

13. The UE of claim 1, wherein, to transmit the uplink shared channel, the one or more processors are individually or collectively operable to execute the code to cause the UE to:
transmit the uplink shared channel according to an orthogonal frequency division multiplexing based transmit waveform.

14. The UE of claim 1, wherein:
the uplink control information comprises one or more of channel state information or scheduling request information.

15. A network entity, comprising:
one or more memories storing processor-executable code; and
one or more processors coupled with the one or more memories and individually or collectively operable to execute the code to cause the network entity to:
obtain an uplink shared channel comprising uplink control information multiplexed with shared data; and
decode, as part of a demultiplexing procedure for demultiplexing the uplink control information from the shared data of the uplink shared channel, the uplink control information from a set of resource elements associated with the uplink shared channel according to a time-first mapping scheme.

16. The network entity of claim 15, wherein, to decode the uplink control information from the set of resource elements, the one or more processors are individually or collectively operable to execute the code to cause the network entity to:
decode a set of first portions of the uplink control information from a first group of resource elements that share a first subcarrier, wherein the set of first portions are distributed on the first subcarrier and across a plurality of symbols according to the time-first mapping scheme.

17. The network entity of claim 16, wherein, to decode the uplink control information from the set of resource elements, the one or more processors are individually or collectively operable to execute the code to cause the network entity to:
decode, based at least in part on the first subcarrier being devoid of available resource elements, a set of second portions of the uplink control information from a second group of resource elements that share a second subcarrier, wherein the set of second portions are distributed within the second subcarrier and across at least a portion of the plurality of symbols according to the time-first mapping scheme.

18. The network entity of claim 15, wherein, to decode the uplink control information from the set of resource elements, the one or more processors are individually or collectively operable to execute the code to cause the network entity to:
decode each portion of a first set of portions of the uplink control information from respective first resource elements on non-overlapping subcarriers in a frequency-domain and non-overlapping slots in a time-domain.

19. The network entity of claim 18, wherein, to decode the uplink control information from the set of resource elements, the one or more processors are individually or collectively operable to execute the code to cause the network entity to:
decode each portion of a second set of portions of the uplink control information from respective second resource elements, wherein each respective second resource element is decoded from a same subcarrier as a respective first resource element and is decoded from a different slot than the respective first resource element.

20. The network entity of claim 15, wherein, to decode the uplink control information from the set of resource elements, the one or more processors are individually or collectively operable to execute the code to cause the network entity to:
decode each portion of a first set of portions of the uplink control information from respective first adjacent resource elements that are adjacent, in a time domain, to respective third resource elements that are for reference signaling, wherein the first set of portions are distributed within a first subcarrier according to the time-first mapping scheme.

21. The network entity of claim 20, wherein, to decode the uplink control information from the set of resource elements, the one or more processors are individually or collectively operable to execute the code to cause the network entity to:
decode, based at least in part on decoding from all first adjacent resource elements, each portion of a second set of portions of the uplink control information from respective second adjacent resource elements that are adjacent, in the time domain, to respective fourth resource elements that are for reference signal information, wherein the second set of portions are distributed within a second subcarrier according to the time-first mapping scheme.

22. The network entity of claim 15, wherein, to decode the uplink control information from the set of resource elements, the one or more processors are individually or collectively operable to execute the code to cause the network entity to:
decode each portion of a first set of portions of the uplink control information from respective first resource elements that are adjacent, in a time domain, to respective third resource elements that are for reference signal information, wherein the respective first resource elements are on non-overlapping subcarriers in a frequency-domain and in non-overlapping slots in a time-domain.

23. The network entity of claim 22, wherein, to decode the uplink control information from the set of resource elements, the one or more processors are individually or collectively operable to execute the code to cause the network entity to:
decode each portion of a second set of portions of the uplink control information from respective second resource elements that are adjacent, in the time domain, to respective fourth resource elements that are for reference signal information, wherein the respective second resource elements are on second non-overlapping subcarriers in the frequency-domain and in second non-overlapping slots in the time-domain, and wherein each respective second resource element is decoded from a same subcarrier as a respective first resource element and is decoded from a different slot than the respective first resource element.

24. The network entity of claim 15, wherein, to decode the uplink control information, the one or more processors are individually or collectively operable to execute the code to cause the network entity to:
decode the uplink control information according to the time-first mapping scheme based at least in part on whether a per-codeword power shaping procedure is used to transmit the uplink control information.

25. The network entity of claim 15, wherein, to decode the uplink control information, the one or more processors are individually or collectively operable to execute the code to cause the network entity to:
decode hybrid automatic repeat request acknowledgement information.

26. The network entity of claim 25, wherein decoding the uplink control information according to the time-first mapping scheme is based at least in part on a quantity or a percentage of hybrid automatic repeat request acknowledgement information in the uplink control information satisfying a threshold.

27. The network entity of claim 15, wherein, to obtain the uplink shared channel, the one or more processors are individually or collectively operable to execute the code to cause the network entity to:
obtain the uplink shared channel according to an orthogonal frequency division multiplexing based transmit waveform.

28. The network entity of claim 15, wherein:
the uplink control information comprises one or more of channel state information or scheduling request information.

29. A method for wireless communications at a user equipment (UE), comprising:
generating uplink control information associated with the UE;
allocating, as part of a multiplexing procedure for multiplexing the uplink control information with shared data for an uplink shared channel, the uplink control information to a set of resource elements associated with the uplink shared channel according to a time-first mapping scheme; and
transmitting the uplink shared channel comprising the uplink control information multiplexed with the shared data based at least in part on the allocating.

30. A method for wireless communications at a network entity, comprising:
obtaining an uplink shared channel comprising uplink control information multiplexed with shared data; and
decoding, as part of a demultiplexing procedure for demultiplexing the uplink control information from the shared data of the uplink shared channel, the uplink control information from a set of resource elements associated with the uplink shared channel according to a time-first mapping scheme.
